(19) United States
(12) Patent Application Publication
(10) Pub. No.: US 2025/0102015 A1
(43) Pub. Date: Mar. 27, 2025

(54) BEARING SYSTEM AND METHOD OF OPERATING THE SAME

(71) Applicant: Gregory Michael Nelson, Nottingham (GB)

(72) Inventor: Gregory Michael Nelson, Nottingham (GB)

(73) Assignee: FRAZER-NASH CONSULTANCY LTD, Leatherhead (GB)

(21) Appl. No.: 18/890,603

(22) Filed: Sep. 19, 2024

Related U.S. Application Data
(60) Provisional application No. 63/584,581, filed on Sep. 22, 2023.

(51) Int. Cl. F16C 32/04

(52) U.S. Cl. CPC F16C 32/04

(57) ABSTRACT

A bearing system and method of operating the same that may include an outer bearing and an inner bearing, and a bearing engagement system configured to control a rotation of the inner bearing relative the outer bearing. In examples, the bearing may include a hybrid bearing having a roller bearing and a gas bearing such as a foil bearing, leaf-type bearing, or a tilt plate bearing. The bearing engagement system may include a displacer configured to linearly translate at least the inner bearing, displace an interface element, or both, and/or an electromagnet configured to generate a magnetic field to apply a magnetic torque to the inner bearing.

This application claims the benefit of U.S. Provisional Application No. 63/584,581, filed Sep. 22, 2023, which is incorporated herein by reference in its entirety.

### FIELD OF INVENTION

The present invention relates to a bearing system and method of operating the bearing system.

### BACKGROUND

The hybrid bearings can provide the advantage of two or more bearings at one coupling site. It has been known to couple a rotor to a stator using dual bearing systems that include a hybrid structure involving two different yet concentrically arranged bearings. However, although some work has been done in the field to implement an operational control of a hybrid bearing, effective and reliable methods are not widely available and this has limited the application of dual bearing systems.

### SUMMARY OF THE INVENTION

Exemplary embodiments of a bearing system and method of operating the bearing system can substantially obviates one or more of the problems due to limitations and disadvantages of the related art.

In examples, the bearing system and method of operating the bearing system as described may provide a design that may be implemented as lubricant-free and still able to work at high speeds in large machines. Gas bearings work well for high speeds but for larger machines are limited by rubbing at low speeds when they cannot generate a gas film, as such their use can be limited. Instead, larger high-speed machines typically always use lubricated bearings or active magnetic bearings. In examples, it may be desirable to avoid the use of a lubricant such as oil. the bearing system and method of operating the bearing system as described may as described herein may allow application of a lubricant-free bearing to larger high-speed machines by employing a dual bearing system that may be able to switch between two bearings to accommodate low rotational speeds and high rotational speeds.

In examples, the bearing system and method of operating the bearing system as described may provide a design able to switch between two bearings to provide back bearing functionality, lower friction, increase dampening, or any other desirable need.

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In examples, provided is a bearing system that may include: a dual bearing that may include an inner bearing; and an outer bearing; and a bearing engagement system configured to control a rotation of the inner bearing, the bearing engagement system that may include: a displacer configured to linearly translate at least the inner bearing, displace an interface element, or both; or an electromagnet configured to generate a magnetic field to apply a magnetic torque to the inner bearing.

In examples, the dual bearing may include a hybrid dual bearing wherein the inner bearing may be different from the outer bearing.

In examples, the dual bearing is free of lubricant.

In examples, the dual bearing may include a dual radial wherein the outer bearing may be concentric with and surrounds the inner bearing or a dual axial bearing wherein the outer bearing and the inner bearing are adjacent and side-by-side to each other.

In examples, the inner bearing may include a gas bearing, and the outer bearing may include a ball bearing, a roller bearing, a lubricant, or any combination thereof.

In examples, the outer bearing may include a gas bearing, and the inner bearing may include a ball bearing, a roller bearing, a lubricant, or any combination thereof.

In examples, the bearing engagement system may include the displacer and the electromagnet configured to generate a magnetic field to apply a magnetic torque to the inner bearing.

In examples, the bearing engagement system may include the displacer that may include one or more linear actuators and one or more tracks.

In examples, the bearing engagement system may include one or more interface elements. In examples, at least one interface element of the one or more interface elements is: located on a portion of a rotor and configured to couple at least a portion of the inner bearing to the rotor; or located on a portion of a stator and configured to couple at least a portion of the inner bearing to the stator.

In examples, at least a first interface element of the one or more interface elements may be located on a portion of a stator and configured to couple at least a portion of the inner bearing to the stator, and at least a second interface element of the one or more interface elements may be located on a portion of a rotor and configured to couple at least a portion of the inner bearing to the rotor.

In examples, the bearing engagement system may include the electromagnet configured to generate a magnetic field to induce a magnetic torque to the inner bearing, wherein the electromagnet may be located on a stator or on a rotor.

In examples, the bearing system may include a vibration dampener.

In examples, the bearing system may include a controller configured to control the displacer, the electromagnet, or both. In examples, the controller may be configured to stop the rotation of the inner bearing at a predetermined angular position.

In examples, provided is a method of controlling a rotation of an inner bearing relative to an outer bearing in a dual bearing that may include controlling an interaction between the inner bearing and at least one interface element by: laterally displacing the inner bearing, an interface element, or both; applying a magnetic torque to the inner bearing; or both.

In examples, the method may include controlling the interaction between the inner bearing and the interface element by laterally displacing the inner bearing, an interface element, or both.

In examples, the at least one interface element may include a first interface element and a second interface element, and wherein controlling the interaction between the inner bearing and the at least one interface element may include switching between contacting the inner bearing with the first interface element and contacting the inner bearing with the second interface element.

In examples, a first interface element may be provided on a portion of a rotor and a second interface element may be provided on a stator, that may include: causing the inner bearing to rotate with the rotor when contacting the inner bearing with the first interface element; and causing the inner bearing to remain substantially still relative to the stator when contacting the inner bearing with the second interface element.

In examples, the method may include applying the magnetic torque to the inner bearing using a magnetic field by controlling one or more electromagnets to control the magnetic field. In examples, applying the magnetic torque to the inner bearing may include impeding the rotation of the inner bearing to maintain the inner bearing substantially still.

In examples, the inner bearing may include a gas bearing and the method may include: controlling the interaction between the inner bearing and at least one interface element or applying magnetic torque to the inner bearing using an electromagnetic field based at least in part on a status of the inner bearing, of a rotor, or both.

In examples, the inner bearing may include a foil bearing or a leaf-type bearing and wherein controlling the interaction between the inner bearing and at least one interface element or applying magnetic torque to the inner bearing using an electromagnetic field may be based at least in part on a status of the inner bearing, wherein the status of the inner bearing may include a rotational speed of the inner bearing, a rotational speed of the outer bearing, presence of an air or gas film adjacent to a surface of the inner bearing, or any combination thereof.

In examples, the inner bearing may include a foil bearing or a leaf-type bearing and the method may include causing the inner bearing to rotate with the rotor when the rotor may be below a threshold rotational speed, and causing the inner bearing to become substantially still to induce formation of an air or other gas film to form between the inner bearing and a rotor once the rotor reaches a threshold rotational speed.

In examples, the inner bearing may include a foil bearing or a leaf-type bearing and the method may include causing the inner bearing to rotate in an opposite direction relative to the rotor when the rotor may be below a threshold rotational speed, and causing the inner bearing to become substantially still to induce formation of an air or other gas film to form between the inner bearing and a rotor once the relative rotational speed between the rotor and the inner bearing reaches a threshold value.

In examples, provided is a system that may include: a rotor; a stator; a bearing that may include an inner bearing; and an outer bearing, the outer bearing connected to the stator; and a bearing engagement system configured to control a rotation of the inner bearing, the bearing engagement system that may include: a displacer configured to laterally displace at least the inner bearing, displace an interface element, or both; or an electromagnet configured to generate a magnetic field to apply a magnetic torque to the inner bearing.

In examples, the bearing engagement system may include the displacer configured to displace the inner bearing, and wherein the rotor may include a first interface element, the stator may include a second interface element, and the displacer may include a linear actuator configured to displace the inner bearing to contact the first interface element or the second interface element, wherein when in contact with the inner bearing the first interface element may be configured to cause the inner bearing to rotate with the rotor and the second interface element may be configured to maintain the inner bearing still with the stator.

In examples, the bearing engagement system may include the displacer configured to displace an interface element, wherein the interface element may be located on a rotor protrusion extending from the rotor, or from a stator protrusion extending from the stator, the displacer may include a linear actuator configured to displace the rotor protrusion or the stator protrusion towards and away from the inner bearing to cause the interface element to contact or separate from the inner bearing and thereby to engage or disengage the inner bearing.

In examples, the bearing engagement system may include the electromagnet, wherein the electromagnet may include one or more electromagnets and may include a controller configured to control operation of the one or more electromagnets.

In examples, the inner bearing may include a gas bearing, and the outer bearing may include a roller bearing, a ball bearing, a lubricated bearing, or any combination thereof.

In examples, the inner bearing may include a roller bearing, a ball bearing, a lubricated bearing, or any combination thereof and the outer bearing may include a gas bearing.

In examples, the bearing may include a radial bearing or an axial bearing.

In examples, the bearing may include a hybrid bearing where the inner bearing may be different from the outer bearing.

In examples, the bearing system may be configured such that the outer bearing may be engaged when the inner bearing rotates.

In examples, the bearing system may include a vibration dampener.

In examples, the bearing system may include a controller configured to control the displacer, the electromagnet, or both.

In examples, the bearing may be lubricant free.

Any combination of the above-listed features may be implemented without departing from the spirit or scope of this disclosure. It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A-1D illustrate examples of dual radial bearings.

FIGS. 2A-2C illustrate an example bearing system that involves a displacer including lateral displacement and/or linear translation of the radial bearing between two interface elements.

FIGS. 2D-2J illustrate examples of bearing systems that involve a displacer configured to displace one or more interface elements to contact a radial bearing.

FIG. 3A illustrates an example of a bearing system that involves the use of one or more electromagnets to impose a magnetic torque on at least a portion of a radial bearing.

FIG. 3B illustrates an example of a bearing system utilizing a combination of one or more displacers and one or more electromagnets to control the operation of the radial bearing.

FIGS. 4A and 4B illustrate an example of a bearing system that involves a displacer including lateral displacement and/or linear translation of a radial bearing and/or one or more interface elements wherein the dual radial bearing is inverted when compared to the radial bearing discussed with reference to FIGS. 2A-2D.

FIGS. 4C-4E illustrate an example of a bearing system that involves the use of one or more electromagnets to impose a magnetic torque on at least a portion of a radial bearing wherein the dual radial bearing is inverted when compared to the radial bearing discussed with reference to FIGS. 2A-2D.

FIGS. 5A-5D illustrate examples of bearing systems including a dampener.

FIG. 6 illustrates an example of a dual axial bearing.

FIGS. 7A-7C illustrate examples of bearing systems that include a displacer configured to displace one or more interface elements to contact an axial bearing and/or to displace the axial bearing to contact one or more interface elements.

FIG. 7D illustrates an example of a bearing system that involves the use of one or more electromagnets to impose a magnetic torque on at least a portion of an axial bearing.

FIGS. 7E and 7F illustrate examples of a bearing system that include a displacer including lateral displacement and/or linear translation of one or more interface elements and/or of the axial bearing wherein the dual axial bearing is inverted when compared to the axial bearing discussed with reference to FIGS. 7A-7C.

### DETAILED DESCRIPTION OF THE ILLUSTRATED EMBODIMENTS

Reference will now be made in detail to an embodiment of the present invention, examples of which are illustrated in the accompanying drawings.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a Uniform Resource Locator (URL) or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

In examples, described is an arrangement including a bearing system including a bearing and a bearing engagement system. In examples, the bearing may include a radial bearing or an axial bearing. In examples, the bearing of the bearing system described herein may be free of lubricant. In examples, the bearing may include a dual bearing. In examples, the bearing may include a dual radial bearing. In examples, the bearing may include a dual axial bearing. In examples, a dual radial bearing may include two concentric radial bearings. In examples, two concentric bearings include an outer radial bearing that encircles an inner radial bearing and wherein the center of rotation of the outer radial bearing coincides with the center of rotation of the inner radial bearing. In examples, a dual axial bearing may include two side-by-side axial bearings. In examples, two side-by-side axial bearings may share the same axis of rotation.

In examples, the dual bearing may include a hybrid bearing. In examples, the hybrid bearing may be a hybrid radial bearing or a hybrid axial bearing. In examples, the hybrid bearing may include a gas hybrid bearing, i.e. a dual bearing in which at least one bearing is a gas bearing.

“Gas bearing” (also known as air bearing) as used herein refers to a bearing that when engaged a film of gas or air forms between the rotor or rotating shaft and the bearing. A gas bearing within the scope of this description is not limited to the bearing working with air. In examples, the system as described herein can include a gas bearing that functions with any suitable gas including air. Examples of suitable gas includes air, a noble gas, natural gas, carbon dioxide gas, or any mixtures thereof. As used herein, gas bearing includes bearings that operate with supercritical fluids, for example, supercritical carbon dioxide gas. A non-exhaustive list of examples of gas bearings include foil bearings, leaf-type bearings, and tilting pad bearings.

In examples, the gas may be cooled. In examples, a cooled gas such as cooled air may provide cooling to the bearing system to avoid overheating. In examples, the gas employed in the gas bearing may surround the bearing, the bearing system, and/or the whole machinery in which the bearing and/or bearing system is used. In examples, a gas may be injected or sprayed to the gas bearing using an injector or other like mechanism (not shown). Any combination of gases provided in any combination of manner may be employed. The description herein refers to air and formation of an air film when discussing the functioning of a gas bearing, this is only an example, any gas or other fluid film would be formed in the same manner depending on the gas or fluid present in and/or around the gas bearing.

In examples, a hybrid radial bearing may include a dual bearing of two concentric radial bearings that are different from each other. In examples, dual radial bearing may include an inner radial bearing and an outer axial bearing. For purposes of this description “an outer radial bearing” refers to the radial bearing of the dual radial bearing that is configured to be closest to, fixed to, or contact the stator or a stator protrusion. For purposes of this description, “an inner radial bearing” refers to the radial bearing of the dual radial bearing that is configured to be closest to, fixed to or contact the rotor or a rotor protrusion. In examples, an outer radial bearing encircles or surrounds the inner radial bearing. In examples, the outer radial bearing is concentric with the inner radial bearing. In examples, a hybrid radial bearing may include a radial gas bearing. In examples, a hybrid radial bearing may be a hybrid radial gas bearing. In examples, a hybrid radial bearing may include a hybrid radial foil bearing, e.g. an air foil bearing. In examples, a hybrid radial foil bearing may include a dual radial bearing with a roller or ball radial bearing as the outer radial bearing and a radial gas bearing, e.g. a radial foil bearing, e.g. an air foil bearing, as the inner radial bearing. In examples, the roller or ball radial bearing may be arranged to encircle the radial gas bearing. In examples, the radial gas bearing may be arranged to encircle the roller or ball radial bearing. In examples, the engagement system may be configured to control the operation of the internal radial bearing of the dual radial bearing.

In examples, a dual radial bearing may include an outer ring, a middle ring, and an inner ring. In examples, the outer ring may include an outer surface that can be a housing of the outer radial bearing. In examples, the outer ring and/or housing of the outer radial bearing may be configured to secure and/or connect the radial bearing to a stator. In examples, the inner ring of the inner radial bearing may be configured to secure and/or connect the radial bearing to a rotor. In examples, the connection between the outer ring and/or housing and the stator or between the inner ring and the rotor may be a direct connection, i.e. for example by welding or one or more fasteners. In examples, the connection between the outer ring and/or housing and the stator or between the inner ring and the rotor may be made via an intervening element such as a displacement element as described herein.

In examples, the inner ring may include an inner surface of the inner radial bearing. In examples, the inner ring may be the portion of the radial bearing configured to face and/or contact a rotor. In examples, where the inner radial bearing is a foil bearing, the inner ring can be the top foil of the radial foil bearing. In examples, the middle ring may function as a dividing wall and/or an interface between the outer radial bearing and the inner radial bearing.

In examples, a hybrid axial bearing (a.k.a. thrust bearing) may include a dual bearing of two side-by-side and/or adjacent axial bearings that are different from each other. In examples, in a hybrid axial bearing the two bearings are not concentric and one bearing does not surround the other bearing. In examples, dual axial bearing may include an inner axial bearing and an outer axial bearing. For purposes of this description “an outer axial bearing” refers to the axial bearing of the dual axial bearing that is configured to be closest to, fixed to, or contact the stator or a stator protrusion. For purposes of this description, “an inner axial bearing” refers to the axial bearing of the dual axial bearing that is configured to be closest to, fixed to or contact the rotor or a rotor protrusion. In examples, a hybrid axial bearing may include an axial leaf-type gas bearing, e.g. air or gas film thrust bearing, e.g. an axial leaf-type bearing or an axial foil bearing. In examples, the hybrid axial bearing may be a hybrid axial gas bearing. In examples, a hybrid axial gas bearing may include a dual axial bearing with a roller or ball axial bearing as the outer axial bearing and an axial gas bearing as the inner axial bearing. For example, a hybrid axial gas bearing may be a hybrid axial leaf-type bearing that may include a dual axial bearing with a roller or ball axial bearing as the outer axial bearing and a axial leaf-type bearing, e.g. a thrust bearing, as the inner axial bearing. In examples, a hybrid axial gas bearing may be a hybrid foil axial bearing may include a dual axial bearing with a roller or ball axial bearing as the outer axial bearing and axial foil bearing as the inner axial bearing. In examples, the roller or ball axial bearing may be arranged to be side-by-side and/or be adjacent with the axial leaf-type bearing or axial foil bearing. In examples, the axial leaf-type axial gas bearing may be arranged to be side-by-side and/or be adjacent to the roller or ball axial bearing. In examples, the engagement system may be configured to control the operation of the internal axial bearing of the dual axial bearing.

In examples, a dual axial bearing may include an outer plate, a middle plate, and an inner surface. In examples, the outer plate may include backplate of the outer axial bearing. In examples, the outer plate and/or backplate of the outer axial bearing may be an integral part of a stator. In examples, the outer plate and/or backplate of the outer axial bearing may be configured to secure and/or connect the axial bearing to a stator. In examples, the inner surface of the inner axial bearing may be configured to secure and/or connect the axial bearing to a rotor. In examples, the connection between the outer plate and/or backplate and the stator or between the inner surface and the rotor may be a direct connection, i.e. for example by welding or one or more fasteners.

In examples, the inner surface of the inner axial bearing may be the portion of the axial bearing configured to face and/or contact a rotor or other rotating element. In examples, where the inner axial bearing is a leaf-type bearing, the inner ring can include the leaf petals of the axial leaf-type bearing. In examples, where the inner axial bearing is a axial foil bearing, the inner surface may include a surface of the top foil of the axial foil bearing. In examples, the middle plate may function as a dividing wall and/or interface between the outer axial bearing and the inner axial bearing.

In examples, control of the operation of a dual bearing may include affecting the rotation of the middle ring or plate, inner bearing, and/or inner ring or surface of the dual bearing. In examples, control of the operation of a dual radial bearing may include affecting the rotation of the middle ring, inner radial bearing, and/or inner ring of the dual radial bearing. In examples, control of the operation of a dual axial bearing may include affecting the rotation of the middle plate, inner axial bearing, and/or inner surface of the dual axial bearing. In examples, control of the operation of the bearing (radial or axial) may include a lateral displacement of the dual bearing and/or lateral displacement of a frictional surface. In examples, control of the operation of an axial bearing may include radial displacement of a frictional surface. In examples, the lateral displacement may include a linear translation. In examples, control of the operation of the inner bearing may include contacting at least a portion of the inner bearing with a frictional surface.

In examples, control of the operation of the bearing (radial or axial) may include application of a magnetic field only.

In examples, control of the operation of a dual bearing may include a combination of contacting at least a portion of the middle ring or plate, inner radial bearing, and/or inner ring or surface with a frictional surface and the application of a magnetic field. In examples, control of the operation of a radial bearing may include a combination of contacting at least a portion of the middle ring, inner radial bearing, and/or inner ring with a frictional surface and the application of a magnetic field. In examples, control of the operation of an axial bearing may include a combination of contacting at least a portion of the middle plate, inner axial bearing, and/or inner surface with a frictional surface and the application of a magnetic field.

In examples, control of the operation of the bearing (radial or axial) may allow for the ability to switch operation between the outer bearing (radial or axial) and the inner bearing (radial or axial). In examples, when the inner radial bearing is in a state of free rotation and/or where the middle ring and/or the inner radial bearing is caused to rotate with the rotor, the outer radial bearing may be engaged. In examples, when the middle ring and/or inner radial bearing of the dual radial bearing is in a static state, the inner radial bearing may be engaged. In examples, when the inner axial bearing is in a state of free rotation and/or where the middle plate and/or the inner axial bearing is caused to rotate with the rotor, the outer axial bearing may be engaged. In examples, when the middle plate and/or inner axial bearing of the dual axial bearing is in a static state, the inner axial bearing may be engaged.

In examples, by enabling control of the operation of the bearing (radial or axial) by switching between inner bearing and outer bearing it may be possible to rely on the different bearings based on the conditions. In examples, controlled operation of a dual bearing as described herein may be used to provide a back-up function. In examples, controlled operation of a dual bearing as described herein may be used to allow bearing support couplings experiencing low and high rotational speeds without requiring a lubricant. For example, the system as described herein may take advantage of switching between a ball or roller bearing that is lubricant-free to support lower rotational speed and a gas bearing to support higher rotational speed. Additional features and advantages of the system will be apparent in the following description referencing the drawings.

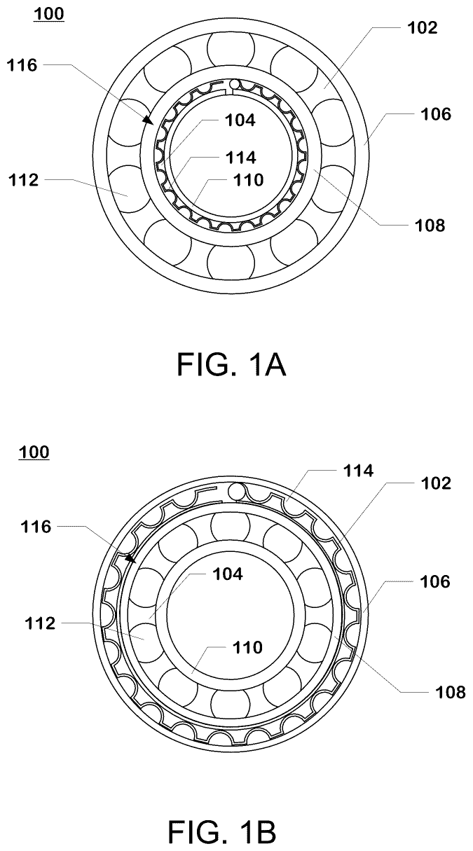

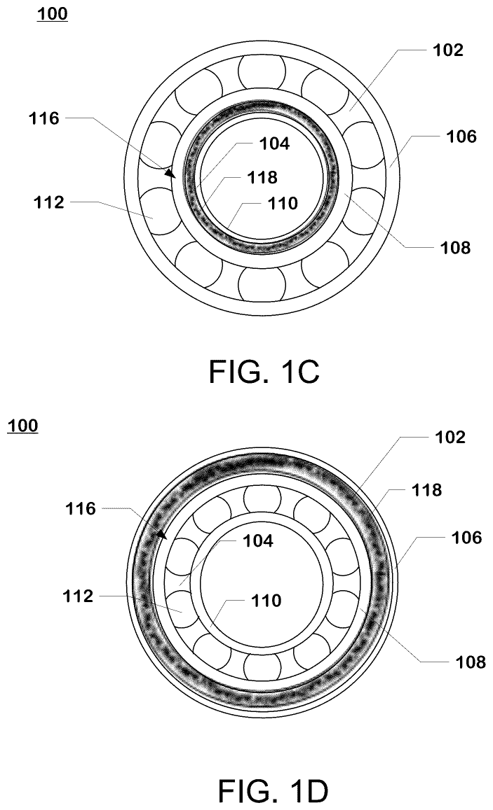

FIGS. 1A-1D illustrate examples of a radial bearing 100. The illustrated radial bearing 100 may include a dual bearing. In examples, the dual bearing may include an outer radial bearing 102 and an inner radial bearing 104. In examples, the outer radial bearing 102 and the inner radial bearing 104 can be concentric. In examples, the inner radial bearing 104 may be encircled by the outer radial bearing 102. In examples, the radial bearing 100 may include an outer ring 106. In examples, the bearing 100 may include a middle ring 108. In examples, the bearing 100 may include an inner ring 110. In examples, the outer ring 106 and middle ring 108 may define and be part of the outer radial bearing 102. In examples, the middle ring 108 and the inner ring 110 may define and be part of the inner radial bearing 104. In examples, middle ring 108 may be part of the outer radial bearing 102 and of the inner radial bearing 104. In examples, in radial bearing 100 if outer ring 106 is maintained at a static state, rotation of middle ring 108 may cause engagement of outer radial bearing 102.

In examples, the outer radial bearing 102 and the inner radial bearing 104 can be independently selected from any type of bearing. In examples, the outer radial bearing 102 and the inner radial bearing 104 may be independently selected from a roller bearing, a ball bearing, foil bearing, a wire mesh bearing, tilted pad radial bearing, a lubricated bearing, a non-lubricated bearing, or any combination thereof. The term “lubricated bearing” as used herein refers to bearings that use a lubricant other than a gas or air, for example, bearings that use a functional fluid such as oil or other liquid, solid, or other non-gaseous materials. In examples, bearing 100 may be free of lubricant both in the outer radial bearing 102 and in the inner radial bearing 104. In examples, the radial bearing 100 can include a dual bearing having a roller bearing or a ball bearing as the outer radial bearing 102 and a gas bearing, e.g. a foil bearing, as the inner radial bearing 104 as, for example, shown in FIG. 1A. The foil bearing may be a bump-type foil bearing as shown in FIG. 1A or a wire mesh foil bearing as, for example, shown in FIG. 1C. In examples, the outer radial bearing 102 may be a lubricated or unlubricated bearing. In examples, as shown in FIG. 1B, the outer radial bearing 102 may be a gas bearing, e.g. a foil bearing, and the inner radial bearing 104 may be a roller bearing or ball bearing. In examples, the foil bearing may be a bump-type foil bearing as shown in FIG. 1B or it may be a wire mesh foil bearing as shown in FIG. 1D. In examples, the inner radial bearing 104 may be a lubricated or unlubricated bearing. In examples, the outer radial bearing 102 may be the same or different from the inner radial bearing 104.

In examples, a roller bearing and/or a ball bearing may include one or more rolling elements 112 such as rollers, spheres, or like structures between two rings such that one ring can rotate while the other ring remains static. In examples, a foil bearing may include a compliant layer 114 such as a bump foil between two rings instead of rolling elements 112.

In examples, a foil bearing can be a bump-type foil bearing, a wire mesh foil bearing, a leaf-type foil bearing, or a tilting pad gas bearing. A bump-type foil bearing may include a series of flexible, bump-shaped foils or bump foils arranged under a top foil, a smooth, flexible foil that contacts the shaft or rotating body. In examples, the bump foils may act like springs, allowing the top foil to conform to the movement of the shaft or rotating body and generate an air or gas film between the shaft or rotating body and the top foil. In examples, an air foil as described herein is a bump-type foil bearing. In examples, as shown in FIG. 1A, the inner ring of a foil bearing, illustrated for example as an air foil bearing, can be the top foil. In examples, a compliant layer 114, e.g. a bump foil, allows for an air or other gas film to be formed between a rotor or other rotating body adjacent the top foil to allow it to rotate with reduced or no friction. As shown in FIG. 1C, a wire mesh foil bearing may include a wire mesh 118 under a top foil in place of the bump-shaped foils described for a bump-type foil bearing. In examples, the wire mesh 118 may include one or more metal wires woven into a mesh pattern. In examples, the wire mesh 118 may include a metal. In examples, wire mesh 118 may include stainless steel, copper, bronze or any combination thereof. In examples, the wire mesh 118 may be compressed or layered to form a flexible, resilient material that can support loads while absorbing shock and vibration. In examples, the wire mesh 118 may act as a compliant layer that may provide support, cushioning, and vibration damping. In examples, wire mesh 118 may allow for an air or other gas film to be formed between a rotor or other rotating body adjacent the top foil to allow it to rotate with reduced or no friction. A radial leaf-type foil bearing (not shown) may include flexible “leaf” foils or petals instead of a continuous bump foil structure. The leaf foils can be stacked or arranged circumferentially around the contact area with a shaft or rotating body and are supported by the bearing housing. Like a foil bearings, leaf foils flex as the shaft rotates, allowing a film of air or gas to form between the shaft and the bearing surface.

In examples, where the outer radial bearing 102 of a dual bearing is a gas bearing, e.g. a foil bearing, middle ring 108 may be replaced by a set of two concentric middle rings wherein the outer middle ring can act as the top foil and be part of the foil bearing and the inner middle ring can be part of the inner bearing. For ease of reference the examples described herein described an example of the system using an air foil bearing; however, any gas bearing may be used, bump-type foil bearing, mesh wire foil bearing, or leaf-type bearing.

In examples, the radial bearing 100 may include a dual bearing that can take advantage of being able to switch operation between the outer radial bearing 102 and the inner radial bearing 104. In examples, a dual bearing may be used to provide a back-up function. For example, if the outer radial bearing 102 malfunctions, the inner radial bearing 104 may be engaged in its place or vice-versa.

In examples, radial bearing 100 may include a hybrid dual bearing where the outer radial bearing 102 is different from the inner radial bearing 104. In examples, a hybrid system may provide the advantage of being able to benefit from the features of the two different bearings by switching between them when most desirable. In examples, outer radial bearing 102 may be a roller or ball bearing and inner radial bearing 104 may be a gas bearing such as a foil bearing, e.g. an air foil bearing. In examples, outer radial bearing 102 may be a gas bearing such as a foil bearing, e.g. an air foil bearing, and inner radial bearing 104 may be a roller or ball bearing. In either of such hybrid configurations, it may be possible to rely on one bearing when the rotational speed of the rotor is below a threshold speed and to rely on the other bearing when the rotational speed is above the threshold. This may allow for the implementation of lubricant free bearing. This may also lead to reduced friction, provide cushioning, and/or dampen vibration when the load on the radial bearing 100 decreases due to rotation. For example, at a start of a rotation of a rotor, the speed of the rotor may be too low to form an air or gas film with a gas bearing and thus it may be desirable to engage the roller bearing or ball bearing by enabling the operation of the radial bearing 100 as the rolling elements 112. As the rotational speed of the rotor increases above a threshold speed, the gas bearing such as the foil bearing may be engaged to allow for a film of air or gas to form between the rotor and the inner ring including the top foil or leaf foils of the radial bearing 100. At this point, the rotor can rotate experiencing low or no friction rotation while maintaining the bearing operation. Similarly, as the rotational speed of the rotor increases, a wire mesh foil bearing may be engaged to allow for lower friction, cushioning, and/or vibration damping. In examples, these advantages can be accomplished by switching the operation of the radial bearing 100 from the outer radial bearing 102 to the inner radial bearing 104 or from inner radial bearing 104 to outer radial bearing 102.

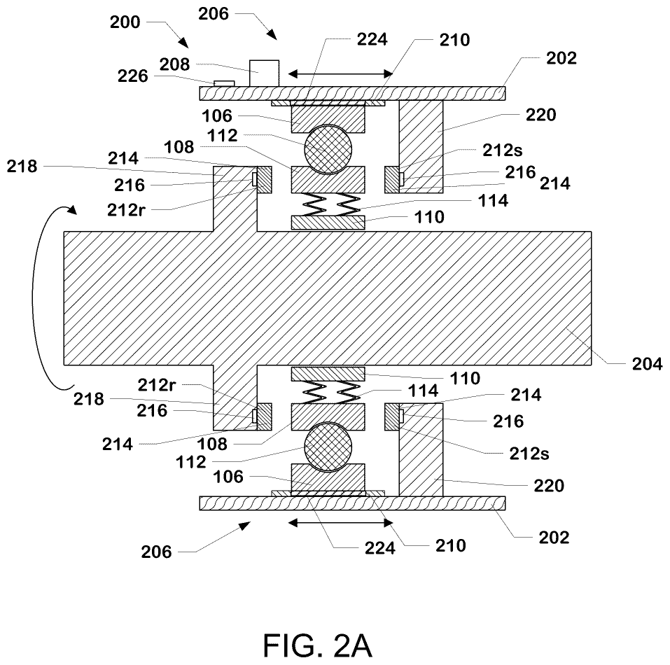

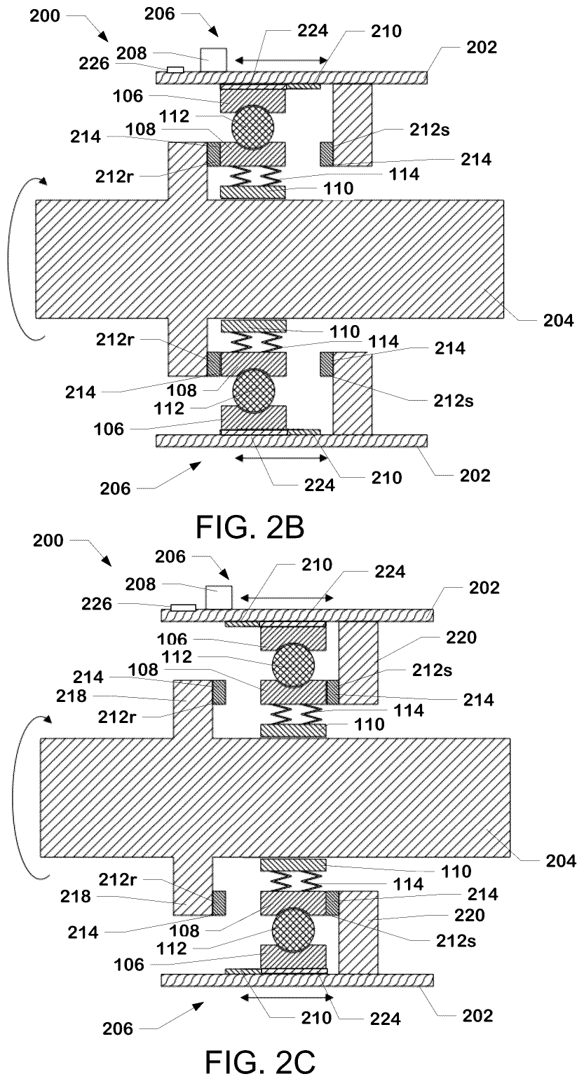

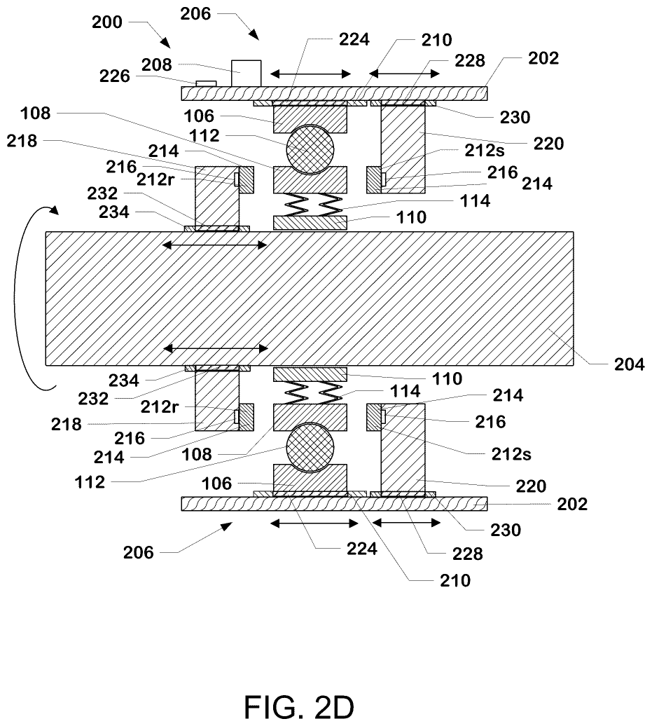

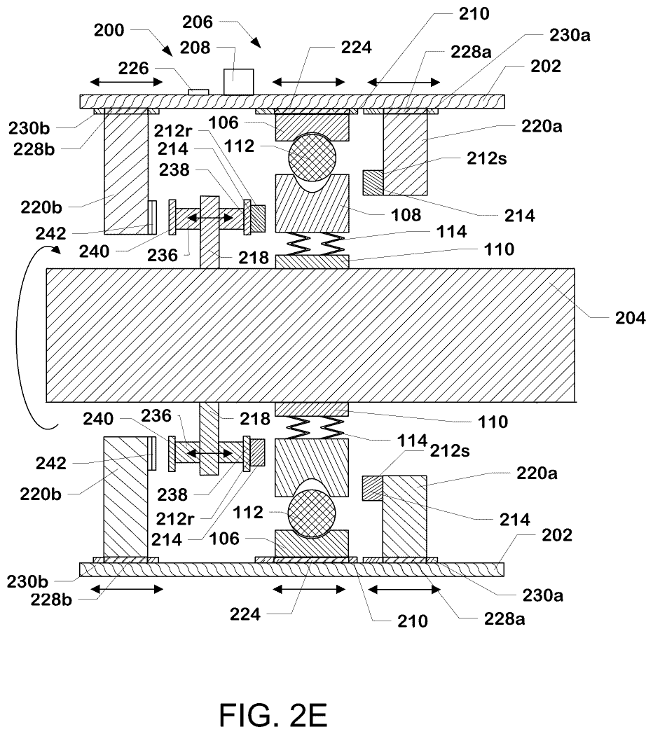

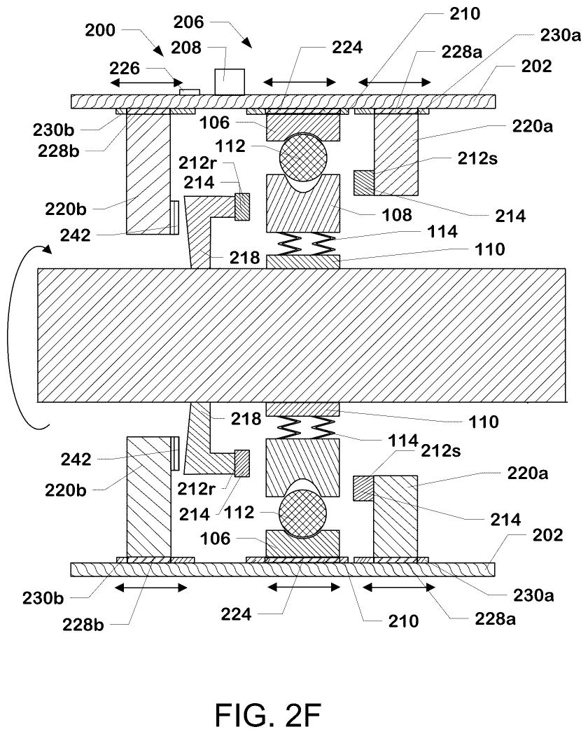

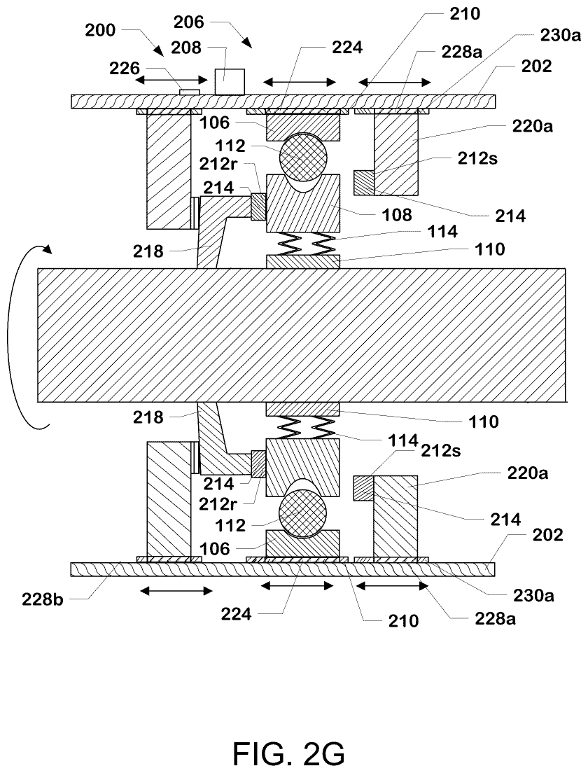

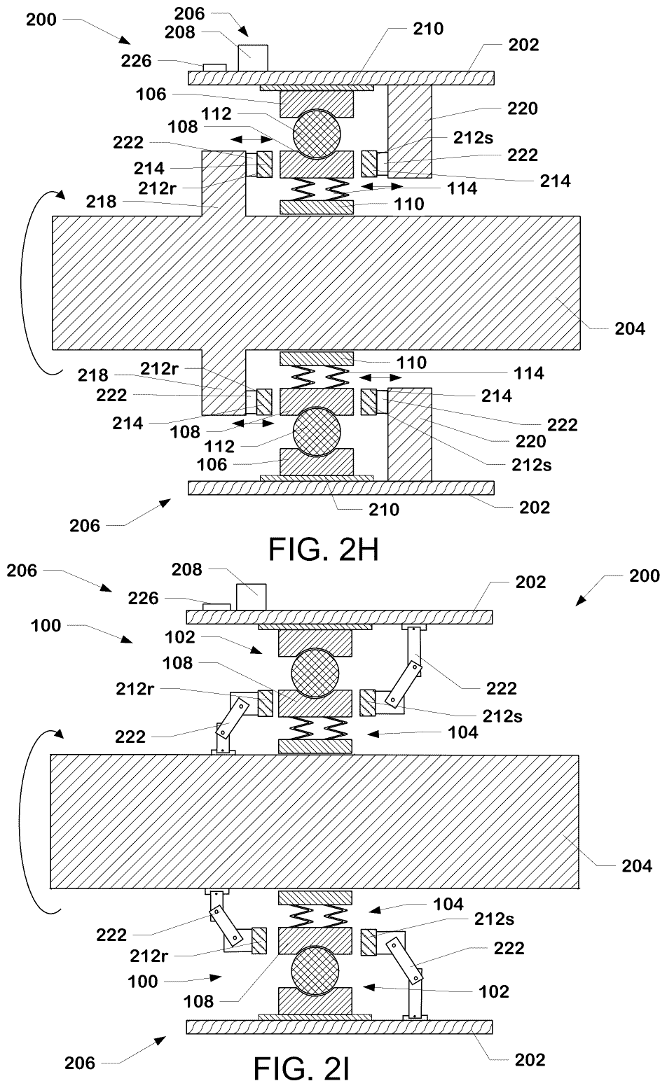

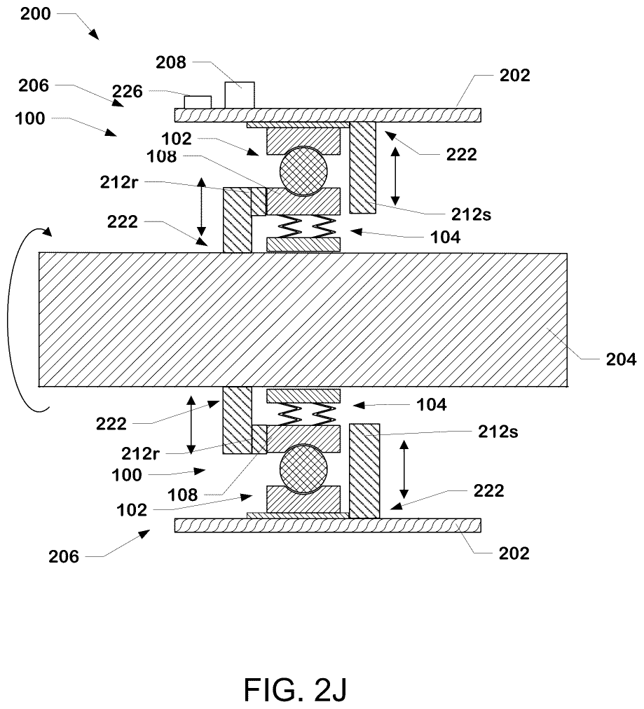

The following description referencing FIGS. 2A-5D provides examples of a bearing system employing a radial bearing 100 that includes a dual bearing with an outer radial bearing 102 that is a roller bearing or ball bearing and an inner radial bearing 104 that is a gas bearing. For purposes of the description the gas bearing is exemplified as a foil bearing such as a bump-type air foil bearing. These are only an example as other types of gas bearings and other types of dual bearing, hybrid or not, may also be equally implemented. For example, in the following described examples, the air foil bearing may be replaced by any type of gas bearing or foil bearing by a wire mesh bearing with no changes otherwise to how the system is implemented or operates. The only difference derived from such a substitution would be the properties the respective bearings exhibit.

In examples, the bearing system as described herein may include a radial bearing 100 combined with a bearing engagement system 200. In examples, the bearing engagement system 200 may be configured to control the operation of radial bearing 100. In examples, the bearing engagement system 200 may be configured to effectuate a switch between operation of the outer radial bearing 102 and the inner radial bearing 104 to thereby take advantage of the dual bearing. In examples, the bearing engagement system 200 may be configured to control a rotation of the inner radial bearing 104, outer radial bearing 102, middle ring 108, inner ring 110, or any combination thereof. In examples, engagement system 200 may be configured to control a rotation of the inner radial bearing 104, middle ring 108, and/or inner ring 110 relative to outer radial bearing 102 and/or outer ring 106.

FIG. 2A illustrates a cross-sectional diagram of an example of a radial bearing 100 together with an example of a bearing engagement system 200. In the examples, radial bearing 100 may include a hybrid dual bearing, and particularly a hybrid air foil bearing with an outer roller bearing and/or ball bearing encircling an inner air foil bearing. As shown, an example cross section of a radial bearing 100, including outer ring 106, rolling element 112, middle ring 108, compliant layer or bump foil 114, and inner ring 110, may be positioned between a stator 202 and a rotor 204. In examples, as shown, the outer radial bearing 102 may be concentric with the inner radial bearing 104. In examples, the outer radial bearing 102 may be functionally connected to and/or coupled to the stator 202. In examples, the outer bearing may surround the inner radial bearing 104. In examples, inner radial bearing 104 may surround, be functionally connected to, and/or coupled to the rotor 204.

In examples, the bearing engagement system 200 may include a displacer 206. In examples, a displacer 206 may be configured to functionally connect at least a portion of the radial bearing 100 to the stator or to the rotor. In examples, a displacer 206 may be configured to functionally connect one or more protrusions to the stator or to the rotor. In the illustrated examples, displacer 206 is shown as functionally connecting and/or coupling at least a portion of the radial bearing 100 to stator 202. In examples, displacer 206 may be configured to linearly translate radial bearing 100, inner radial bearing 104, middle ring 108, or any combination thereof.

In examples, the displacer 206 may include one or more motors 208. In examples, a motor 208 may be any type of suitable motor. In examples, a motor 208 may be an electric motor. In examples, one or more motors 208 may be located at the stator 202 and/or rotor 204.

In examples, the bearing engagement system 200 and/or displacer 206 may include a linear actuator 224. In examples, displacer 206 may include a track 210. In examples, the track 210 may include any design configured for linear translation. In examples, the track 210 may have a length that is greater than a lateral thickness (or cross-sectional width) of radial bearing 100 and/or of outer radial bearing 102. In examples, the bearing engagement system 200 and/or displacer 206 may include a linear actuator 224 with a track 210. In examples, the linear actuator 224 and track 210 may be configured to linearly translate the entire radial bearing 100. In examples, the linear actuator 224 may be actuated by one or more motors 208.

In examples, as illustrated in FIGS. 2B and 2C, as the radial bearing 100, inner radial bearing 104, middle ring 108, or any combination thereof is translated at least a portion of inner radial bearing 104 and/or middle ring 108 may contact an interface element 212.

In examples, as shown in FIG. 2A, the bearing engagement system 200 may include one or more interface elements 212 (e.g., 212r and 212s). In examples, an interface element 212 may include a friction pad 214. In examples, a friction pad 214 may have at least a frictional surface configured to interface with at least a portion or sidewall of radial bearing 100, middle ring 108, and/or inner radial bearing 104. In examples, an interface element 212 may include materials such as ceramics, polymers, rubber, metal, or any combination thereof. In examples, the interface element 212 may include a ceramic friction pad. In examples, an interface element 212 may include a magnetic material, an electromagnetic material, or a combination thereof. In examples, an interface element 212 may include a magnetic surface, a magnet, and/or electromagnet 216. In examples, an interface element 212 may include a combination of a friction pad and a magnetic surface, magnet and/or electromagnet. In examples, an interface element 212 may be configured to affect the rotation of the inner radial bearing 104 when pressed against a portion of inner radial bearing 104 and/or middle ring 108. In examples, an interface element 212 may be configured to couple at least a portion of inner radial bearing 104 and/or middle ring 108 to either the stator 202 or the rotor 204. In examples, by coupling at least a portion of inner radial bearing 104 and/or middle ring 108 to either the stator 202 or the rotor 204, an interface element 212 may affect the rotation of the inner radial bearing 104 and/or of middle ring 108. In examples, an interface element 212 may be configured to engage a sidewall 116 of middle ring 108. In examples, when pressed against a sidewall 116 of middle ring 108, an interface element 212 may cause the middle ring 108 to stick or affix to the interface element 212. In this manner, the rotation of the middle ring 108 and consequently, the rotation of the inner radial bearing 104 and/or outer radial bearing 102 may be controlled.

In examples, a first interface element 212r may be provided on the rotor 204. In examples, a first interface element 212r may be provided on a portion of the rotor 204. In examples, a second interface element 212s may be provided on the stator 202. In examples, a second interface element 212s may be provided on a portion of the stator 202. In examples, the rotor 204 may include one or more rotor protrusions 218 with one or more first interface elements 212r provided on the one or more rotor protrusions 218. In examples, the stator 202 may include one or more stator protrusions 220 with one or more second interface elements 212s provided on the one or more stator protrusions 220.

In examples, a first interface element 212r may be provided on a rotor protrusion 218. In examples, a second interface element 212s may be provided on a stator protrusion 220. In examples, the first interface element 212r and/or the second interface element 212s may be located on respective portions of rotor and/or stator other than at a protrusion 218 or 220. In examples, the first interface element 212r and the second interface element 212s may be opposite each other. In examples, the first interface element 212r and the second interface element 212s may be arranged to face each other. In examples, the first interface element 212r and the second interface element 212s may be sufficiently spaced apart to allow radial bearing 100 and/or inner radial bearing 104 and/or middle ring 108 to linearly translate between them.

In examples, it may be possible to control the interaction between one or more interface elements 212 and the inner radial bearing 104 and/or middle ring 108. In examples, the interaction between one or more interface elements 212 and the inner radial bearing 104 and/or middle ring 108 may be controlled by switching between contacting the inner radial bearing 104 and/or middle ring 108 with a first interface element 212r and a second interface element 212s. In examples, the interaction between one or more interface elements 212 and the inner radial bearing 104 and/or middle ring 108 may be controlled by laterally displacing and/or linearly translating radial bearing 100, middle ring 108, and/or inner radial bearing 104. In examples, the lateral displacement and/or linear translation of radial bearing 100, middle ring 108, and/or inner radial bearing 104 may be towards an interface element 112 and/or towards the surface of a stator 202 or the surface of a rotor 204. In examples, lateral displacement and/or the linear translation may be towards an interface element 112 located on a stator surface or a rotor surface. In examples, the lateral displacement and/or linear translation of the radial bearing 100, inner radial bearing 104, middle ring 108, or any combination thereof may cause middle ring 108 and/or inner radial bearing 104 to contact an interface element 212. In examples, by displacing or translating the radial bearing 100, inner radial bearing 104, middle ring 108, or any combination thereof between the first interface element 212r and the second interface element 212s, the bearing engagement system 200 may be able to control the operation of the radial bearing 100 to engage and disengage the inner radial bearing 104 and outer radial bearing 102.

FIGS. 2B and 2C illustrate an example switching operation that can be effectuated by bearing engagement system 200. FIG. 2B illustrates an example in which displacer 206, via a motor 208, translates the radial bearing 100, inner radial bearing 104, middle ring 108, or any combination thereof toward the first interface element 212r. In examples, the first interface element 212r may be provided on a surface of rotor 204. In examples, as illustrated, interface element 212r may be provided at a surface of rotor protrusion 218. As this translation occurs, the first interface element 212r and a first sidewall 116a of inner radial bearing 104 and/or middle ring 108 come in contact. In examples, the friction provided by the friction pad 214r and/or by magnetic field provided by electromagnet 216r that the first sidewall 116a experiences at first interface element 212r may cause the middle ring 108 to assume a fixed location relative to the first interface element 212r. In examples, during this state, the rotation of rotor 204 may cause rotation of the first interface element 212r that is attached to the rotor protrusion 218. As such, in this state, as the first interface element 212r is rotating, the middle ring 108 and/or inner radial bearing 104 are also rotating with the rotor. In examples, while in this state the inner ring 110 may also be contacting a surface of rotor 204. In examples, as inner radial bearing 104 rotates with the rotor, outer radial bearing 102 is engaged with the middle ring 108 rotating while outer ring 106 remains fixed to a stator 202. In examples, the rotation of middle ring 108 while outer ring 106 remains in a fixed position may be enabled by the one or more rolling elements 112, a lubricant, or a combination of both.

In examples, based at least on the status of radial bearing 100 or portion thereof, and/or of the rotor 204 it may be possible to control the interaction between the inner radial bearing 104 and/or middle ring 108 and one or more interface elements 212. In examples, the status of the rotor 204 and/or of the radial bearing 100 or portion thereof, such as for example the status of an air foil bearing if included in the radial bearing 100, may include, but not be limited to, the rotational speed of the rotor 204, the rotational speed of the rotor 204 relative the inner radial bearing 104, the rotational speed of the inner radial bearing 104, the rotational speed of the outer radial bearing 102, the rotational speed of the air foil bearing if present (whether it be the inner radial bearing 104 or the outer radial bearing 102), the rotational speed of the non-air foil bearing (whether it be the inner radial bearing 104 or the outer radial bearing 102), the presence of an air or other gas film adjacent a surface, such as for example the surface of the top foil, of the air foil bearing, or any combination thereof. It should be recognized that when the inner radial bearing 104 is allowed to rotate with the rotor 204, the rotational speed of the inner radial bearing 104 may be the same as the rotational speed of the rotor 204. In such cases, detection of rotational speed of the rotor 204 may also provide the rotational speed of the inner radial bearing 104 and vice versa. In examples, one or more sensors (not shown) may be used to detect one or more of these status indicators for the air foil bearing and/or of the rotor. For example, it may be possible using one or more sensors to detect if the rotation of rotor 204, inner radial bearing 104, outer radial bearing 102, or of an air foil bearing, exceeds or reaches a point above a predetermined threshold rotational speed.

In examples, based at least on the status of the air foil bearing and/or of the rotor, it may be possible to control the interaction between the inner radial bearing 104 and/or middle ring 108 and one or more interface elements 212. In examples, at a given status of the air foil bearing and/or rotor, for example, at a given rotational speed of the air foil bearing and/or rotor, to reduce friction exerted onto the rotor surface the bearing engagement system 200 may effectuate a switch in the operation of radial bearing 100 from the roller and/or ball bearing used for outer radial bearing 102 to the air foil bearing used as inner radial bearing 104 to promote the formation of a film of air between inner ring 110 and the surface of the rotor 204. In examples, one or more suitable controllers 226 that may include one or more microprocessors, memory, hardware and/or software instructions, may be used to enable the control using one or more signals based on the sensed status. In examples, the switch may be triggered based on sensor information and/or a set of stored and/or manually entered instructions. In examples, the one or more controllers 226 may control motor 208. In examples, motor 208 may be operated to laterally displace and/or linearly translate the radial bearing 100, inner radial bearing 104, middle ring 108, or any combination thereof toward the second interface element 212s as, for example, shown in FIG. 2C. In examples, the lateral displacement and/or linear translation may be guided by track 210. In examples, as the radial bearing 100, inner radial bearing 104, middle ring 108, or any combination thereof is translated towards the second interface element 212s, the second sidewall 116b of inner radial bearing 104 and/or middle ring 108, at the opposite side of the first sidewall 116a, is moved towards and eventually pressed against second interface element 212s. In examples, the friction exerted by friction pad 214s and/or magnetic field by electromagnet 216s that the second sidewall 116b experiences at second interface element 212s may cause the middle ring 108 to assume a fixed location relative to the second interface element 212s. In examples, during this state, the stationary or fixed position of the stator 202 maintains the second interface element 212s that is attached to the stator protrusion 220 in a stationary or fixed position. As such, as the second interface element 212s is stationary or in a fixed position, the middle ring 108 and inner radial bearing 104 are also in a stationary or fixed position relative to the stator 202. In this state, the inner radial bearing 104, middle ring 108, and/or inner ring 110 may be maintained substantially still. In this state, the outer radial bearing 102 is not operating. In this state, the inner radial bearing 104 is engaged. In examples, the inner radial bearing 104 allows for the free rotation of the rotor 204 by way of the air or other gas film created between rotor 204 and the inner ring 110. In examples, this can allow for a lowered or no friction rotation of rotor 204.

In examples, the operation of radial bearing 100 may be controlled by bearing engagement system 200 by translating radial bearing 100 between the first interface element 212r and the second interface element 212s as may be desired. In the above examples, the switching can be used to take advantage of a roller and/or ball bearing during lower rotational speed of the rotor and of an air foil bearing for low to no friction rotation at higher rotational speeds of the rotor when lift off speed is reached for a given load. This is only an example. In additional examples, switching may be performed for backup bearing functionality, for other types of bearing combinations, or any other desirable need.

In examples, displacer 206 may be configured to displace one or more interface elements 212 in addition to or in place of displacing radial bearing 100, inner radial bearing 104, and/or middle ring 108. In examples, where displacer 206 is configured only to displace one or more interface elements 212, then radial bearing 100 and/or outer radial bearing 102 and/or the housing of radial bearing 100 may be an integral portion of the stator or may be directly fixed to a stator via one or more fasteners, welding, or any combination thereof. Fasteners may include bolts, screws, nails, brackets, frames, or any other suitable mechanical fastener.

In examples, the interaction between one or more interface elements 212 and the inner radial bearing 104 and/or middle ring 108 may be controlled at least in part by displacing one or more interface elements 212. In examples, the interaction between one or more interface elements 212 and the inner radial bearing 104 and/or middle ring 108 may be controlled by switching between contacting the inner radial bearing 104 and/or middle ring 108 with a first interface element 212r and a second interface element 212s. In examples, the interaction between a first interface element 212r and second interface element 212s and the inner radial bearing 104 and/or middle ring 108 may be controlled by displacing the first and second interface elements 212r and 212s. In examples, the displacement of one or more interface elements 212 may cause inner radial bearing 104 and/or middle ring 108 to contact an interface element 212. In examples, displacing one or more interface elements 212, for example by displacing a first interface element 212r and a second interface element 212s, the bearing engagement system 200 may be able to control the operation of the radial bearing 100 to engage and disengage the inner radial bearing 104 and outer radial bearing 102.

In examples, the interaction between one or more interface elements 212 and the inner radial bearing 104 and/or middle ring 108 may be controlled at least in part by displacing one or more interface elements 212 by the displacement of one or more stator protrusions 220 and/or one or more rotor protrusions 218. In examples, the interaction between one or more interface elements 212 and the inner radial bearing 104 and/or middle ring 108 may be controlled by switching between contacting the inner radial bearing 104 and/or middle ring 108 with a first interface element 212r and a second interface element 212s. In examples, the interaction between a first interface element 212r and second interface element 212s and the inner radial bearing 104 and/or middle ring 108 may be controlled at least in part by displacing a stator protrusion 220 and/or a rotor protrusion 218. In examples, the displacement of a stator protrusion 220 and/or of a rotor protrusion 218 may cause inner radial bearing 104 and/or middle ring 108 to contact an interface element 212. In examples, by displacing rotor protrusion 218 and/or stator protrusion 220, the bearing engagement system 200 may be able to control the operation of the radial bearing 100 to engage and disengage the inner radial bearing 104 and outer radial bearing 102. In examples, displacement of a rotor protrusion 218 or of a stator protrusion 220 may include linear displacements. In examples, a linear displacement of a stator protrusion 220 and/or of a rotor protrusion 218 may be accomplished in the same manner described for radial bearing 100. In examples, a linear displacement of a stator protrusion 220 may be accomplished using one or more linear actuators 228 (e.g. 228a and 228b) and tracks 230 (e.g. 230a and 230b). In examples, a linear displacement of a rotor protrusion 218 may be accomplished using one or more linear actuators 232 and tracks 234. In examples, a linear actuator 228 or 232 and a track 230 or 234 may be set up and function similarly to linear actuator 224 and track 210 previously described with reference to a displacer 206 for radial bearing 100. In examples, one or more linear actuators 228 and 232 and tracks 230 and 234 may be used to translate a stator protrusion 220 and/or a rotor protrusion 218 in place of translating radial bearing 100.

FIG. 2D illustrates an example in which one or more linear actuators 228 and 232 and tracks 230 and 234 may be used to control the interaction between one or more interface elements 212 and the inner radial bearing 104 and/or middle ring 108 at least in part by displacing one or more interface elements 212 by linear displacement of one or more stator protrusions 220 and/or one or more rotor protrusions 218. As shown, in examples, the one or more linear actuators 228 and 232 and tracks 230 and 234 may be used in combination with linear actuator 224 and track 210 described earlier. In examples, as the stator protrusion 220 translates towards radial bearing 100 via linear actuator 228 and track 230, it can cause interface element 212s to contact the inner radial bearing 104 and/or middle ring 108 of radial bearing 100. In so doing, the outer radial bearing 102 may be disengaged. In examples, as the stator protrusion 220 translates away from radial bearing 100 via linear actuator 228 and track 230, it can cause interface element 212s to separate or move away from the inner radial bearing 104 and/or middle ring 108 of radial bearing 100. In so doing, the outer radial bearing 102 may be engaged and operate. In examples, as the rotor protrusion 218 translates towards radial bearing 100 via linear actuator 232 and track 234, it can cause interface element 212r to contact the inner radial bearing 104 and/or middle ring 108 of radial bearing 100. In so doing, the inner radial bearing 104 may be disengaged. In examples, as the rotor protrusion 218 translates away from radial bearing 100 via linear actuator 232 and track 234, it can cause interface element 212r to separate or move away from the inner radial bearing 104 and/or middle ring 108 of radial bearing 100. In so doing, the inner radial bearing 104 may be engaged and operate.

FIG. 2E illustrates an example of a bearing engagement system in which one or more linear actuators 228 (e.g. 228a and 228b) and one or more tracks 230 (e.g. 230a and 230b) may be employed to linearly translate two or more stator protrusions 220 to control the interaction between one or more interface elements 212 and the inner radial bearing 104 and/or middle ring 108. In examples, FIG. 2H differs from FIG. 2D in that the rotor protrusion 218 remains in a fixed position relative to the rotor 204. In this manner, linear actuator 232 and track 234 on rotor 204 are not required.

In examples, as shown in FIG. 2E, a bearing direct engagement stator protrusion 220a may be functionally connected and/or coupled with stator 202 via a first linear actuator 228a and track 230a. In examples, a thrust bearing engagement stator protrusion 220b may be functionally connected and/or coupled with stator 202 via a second linear actuator 228b and track 230b. In examples, as the bearing direct engagement stator protrusion 220a linearly translates towards radial bearing 100, it may cause interface element 212s to contact inner radial bearing 104 and/or middle ring 108 of radial bearing 100. As previously discussed, when interface element 212s contacts inner radial bearing 104 and/or middle ring 108 of radial bearing 100, it can cause middle ring 108 to remain at a fixed position, thereby disengaging the outer radial bearing 102 of radial bearing 100. In examples, as the bearing direct engagement stator protrusion 220a linearly translates away radial bearing 100, it may cause interface element 212s to move away from inner radial bearing 104 and/or middle ring 108 of radial bearing 100. In examples, when interface element 212s is not in contact with radial bearing 104 or middle ring 108 of radial bearing 100, the outer radial bearing 102 of radial bearing 100 may be engaged and operate.

In examples, as also shown in FIG. 2E, a rotor protrusion 218 may include a sliding element 236. In examples, sliding element 236 may be configured or designed to translate in a linear direction parallel to an outer surface of the rotor 204. In examples, sliding element 236 may be a rod or like structure. In examples, sliding element 236 may be configured or designed to return to an original position when a directional force is not applied to it. For example, sliding element 236 may be spring loaded. In examples, sliding element 236 may include press elements 238 and 240 at each lateral end. In examples, a press element may be a plate or other extension of sliding element 236. In examples, press elements 238 and 240 may include the same or different material and have the same or different surface contour. In examples, press elements 238 and 240 may each independently include a suitable material. For example, press element 238 may include a material that allows for attachment with interface element 212r. For example, press element 240 may include a material suitable for the interaction with a thrust bearing 242 as described later. In examples, press elements 238 and 240 may each independently include a metal or metal alloy. In examples, a press element of sliding element 236 may face radial bearing 100. In examples, the press element that faces radial bearing 100 may include an interface element 212. As shown in FIG. 2E, press element 238 may include interface element 212r. In examples, a press element of sliding element 236 may face away radial bearing 100, for example as press element 240 shown in FIG. 2E. In examples, a thrust bearing engagement stator protrusion 220b may be arranged to be functionally connected and/or coupled to stator 202 via a linear actuator 228b and track 230b. In examples, thrust bearing engagement stator protrusion 220b may include a thrust bearing 242. Any suitable thrust bearing may be used as thrust bearing 242. In examples, thrust bearing 242 may be a leaf-type bearing. In examples, thrust bearing 242 may be located at an opposite end of thrust bearing engagement stator protrusion 220b from the stator. In examples, thrust bearing engagement stator protrusion 220b and a thrust bearing 242 may be arranged such that as the thrust bearing engagement stator protrusion 220b translates towards the radial bearing 100, the thrust bearing 242 comes into contact with a press element 240 that faces away from radial bearing 100. As the thrust bearing 242 makes contact with press element 240 it may allow translating thrust bearing engagement stator protrusion 220b to exert a thrust force on press element 240 and thus on sliding element 236. The thrust force exerted onto press element 240 and sliding element 236 may cause sliding element 236 to translate linearly towards radial bearing 100. As sliding element 236 translates towards radial bearing 100, press element 238 facing radial bearing 100 and thus interface element 212r also move towards radial bearing 100. In examples, as interface element 212r is translated toward radial bearing 100 it can come into contact with inner radial bearing 104 and/or middle ring 108 of radial bearing 100. When interface element 212r is in contact with inner radial bearing 104 and/or middle ring 108 of radial bearing 100, the inner radial bearing 104 of radial bearing 100 rotates with rotor 204 and it is thus disengaged. As the thrust bearing engagement stator protrusion 220b is translated away from radial bearing 100, so is the thrust bearing 242. This may result in the thrust force applied to the sliding element 236 to decrease or be removed allowing sliding element 236 to return to its original starting position and thus separating or moving interface element 212r away from radial bearing 100. When interface element 212 is not in contact with inner radial bearing 104 or middle ring 108 of radial bearing 100, the inner radial bearing 104 may be engaged and operate.

In examples, as illustrated in FIGS. 2F and 2G, an example of a bearing engagement system as described with reference to FIG. 2E with a more simplified rotor protrusion 218. As shown, all the features shown in FIGS. 2F and 2G are the same as shown in FIG. 2E except for not including sliding element 236, with press plates 238 and 240. Instead, as shown, rotor protrusion 218 may include a interface element 212, e.g. 212r, at an end opposite from where the rotor protrusion 218 is connected to the rotor 204. In examples, the interface element 212r may be arranged to face radial bearing 100. In examples, the rotor protrusion 218 may extend around the full circumference of rotor 204. In examples, rotor protrusion 218 may be a contiguous plate or a series of strips or prongs. In examples, rotor protrusion 218 may include a flexible material that is able to exhibit non-plastic deformation. In examples, rotor protrusion 218 may include a metal or metal allow. In examples, as shown in FIGS. 2F and 2G, the interface element 212r may be caused to contact inner radial bearing 104 and/or middle ring 108 of radial bearing 100 by exerting a thrust force onto a surface of the rotor protrusion 218 that is opposite the surface of where interface element 212r is located. In examples, as shown in FIG. 2F, the thrust force may be applied via a using a thrust bearing engagement stator protrusion 220b equipped with a thrust bearing 242 in the same manner previously described with reference to FIG. 2E. In examples, when the thrust force is applied, rotor protrusion 218 may be caused to flex or bend towards radial bearing 100 via a non-plastic deformation thereby translating the interface element 212r towards radial bearing 100 until it contacts inner radial bearing 104 and/or middle ring 108 of radial bearing 100. In examples, as shown in FIG. 2G, as the thrust force is lifted, the rotor protrusion 218 may return to its original shape thus translating interface element 212r away from radial bearing 100 which leads to a separation between interface element 212r and radial bearing 100. In this manner, it is possible to engage and disengage the inner radial bearing 104 of radial bearing 100 in the same manner as previously described with reference 2E.

In examples, displacer 206 may include one or more extenders 222. In examples, an extender 222 may include an extension arm or like structure to displace an interface element 212. In examples, as shown in FIGS. 2H-2J, an extender 222 may include a folding arm, a telescoping arm, a mechanical arm, a hydraulic arm, any like structure, or any combination thereof. In examples, an interface element 212 may have an elongated width and be configured to slide out to extend and retract. In such examples, an extender 222 may include a hydraulic or electronic piston or like mechanism configured to push out and retract the interface element 212. As shown in FIGS. 2H-2J, extenders 222 may be used in combination with track 210 described earlier. This is just an example. In examples, extenders 222 may be used instead of having a track 210. In examples, one or more extenders 222 may be operated using one or more motors 208. In examples, the one or more extenders 222 may be controlled by one or more controllers 226 via one or more motors 208. As shown in FIGS. 2H and 2J, the displacement of one or more interface elements 212 may be linear. However, this is only an example. Non-linear displacement as for example shown in FIG. 2I of interface elements 212 may also be possible.

In examples, by operation of one or more extenders 222, alone or in combination with the track 210, can achieve the same function described with reference to FIGS. 2H to 2J. In examples, as shown in FIG. 2H one or more extenders 222 may displace by extending and/or retracting first interface element 212r and the second interface element 212s from respecting rotor protrusion 218 and stator protrusion 220 at each side of the radial bearing 100. In examples, displacement by extension and/or retraction of an interface element 212 may be combined with the lateral displacement and/or linear translation of the radial bearing 100. In examples, as shown in FIG. 2I one or more extenders 222 as mechanical arms may be used to press one or more interface elements 212 against either side of inner radial bearing 104 of radial bearing 100. In examples, the use of a mechanical arm extender may be used in combination with the lateral displacement and/or linear translation of the radial bearing 100. In examples, as shown in FIG. 2J, one or more extenders may be used to extend one or more interface elements 212 from the stator and/or the rotor. In examples, rotor protrusion 218 and/or stator protrusion 220 may not be present. In examples, as an interface element 212 extends from a base of the stator and/or of the rotor it may reach a location where it may contact a sidewall 116 of inner radial bearing 104 and/or middle ring 108. In examples, the extension of an interface element 212 from a base portion of the rotor 204 and/or stator 202 may be conducted in combination with the lateral displacement and/or linear translation of radial bearing 100. In examples, these additional optional implementations of extenders 222 can be used to achieve the same goal of pressing a sidewall 116 of inner radial bearing 104 and/or middle ring 108 against an interface element 212 to control the operation of inner radial bearing 104 and/or outer radial bearing 102 as previously described with reference to FIGS. 2B and 2C.

In examples, the interaction between one or more interface elements 212 and the inner radial bearing 104 and/or middle ring 108 may be controlled by laterally displacing and/or linearly translating radial bearing 100, middle ring 108, and/or inner radial bearing 104 as described with reference to FIGS. 2A-2C. In examples, the interaction between one or more interface elements 212 and the inner radial bearing 104 and/or middle ring 108 may be controlled by displacing one or more interface elements 212 as described with reference to FIGS. 2D-2J. In examples, the interaction between one or more interface elements 212 and the inner radial bearing 104 and/or middle ring 108 may be controlled by a combination of lateral displacement and/or linear translation of radial bearing 100, middle ring 108, and/or inner radial bearing 104, in combination with the displacement of one or more interface elements 212.

In the examples shown in FIGS. 2A-2J, the radial bearing 100 included a foil bearing as the inner radial bearing 104 with a roller or ball bearing at the outer radial bearing 102. This was only an example. As previously stated, the inner radial bearing 104 and the outer radial bearing 102 of radial bearing 100 can each be independently selected to include any desirable bearing to form a hybrid bearing. In examples, the same configurations may be used with a radial bearing 100 in which the foil bearing is the outer radial bearing 102 and a roller or ball bearing is the inner bearing. In examples, where the foil bearing is used as the outer radial bearing 102 the air or gas film may be formed at the interface of the outer radial bearing 102 and inner radial bearing 104. In examples, the air or gas film may form between the top foil of the foil bearing used as the outer radial bearing 102 and the outer ring of the inner radial bearing 104. As previously described, the middle ring 108 may include a set of two concentric rings. In examples, the two concentric rings of middle ring 108 may include the top foil of an air foil bearing used as the outer radial bearing 102, and the housing or outer ring of the inner radial bearing 104.

In examples, if a foil bearing is used as the outer radial bearing 102 and lateral displacement and/or linear translation of the radial bearing 100 or portion thereof is desired, then displacer 206 may include the linear actuator 224 and respective track 210 arranged on the rotor 204 instead of the stator 202 to functionally connect and/or couple the inner ring 110 of the inner radial bearing 104 and/or radial bearing 100 to the rotor 204. In examples, displacer 206 functionally connecting and/or coupling the inner ring to rotor 204 may be configured to linearly translate the inner radial bearing 104 and/or a portion of middle ring 108 of radial bearing 100 to achieve the previously described contacts with the one or more interface elements 212 and cause the middle ring 108 to rotate with the rotor 204 to engage the outer radial bearing 102. In examples, displacer 206 may include a linear actuator and track on the rotor 204 in addition to linear actuator 224 and track 210 provided on the stator 202 to allow for a lateral displacement and/or linear translation of the whole radial bearing 100. In examples, lateral displacement and/or linear translation of the radial bearing 100 may be induced from both the inner ring at the rotor side and the outer ring at the stator side of radial bearing 100 at the same time. In examples, when lateral displacement and/or linear translation of the radial bearing 100 or portions thereof is not desired, the inner ring of inner radial bearing 104 and/or radial bearing 100 may be fixed to the rotor 204 via one or more fasteners, welding, or any combination thereof. As previously described, fasteners may include bolts, screws, nails, brackets, frames, or any other suitable mechanical fastener.

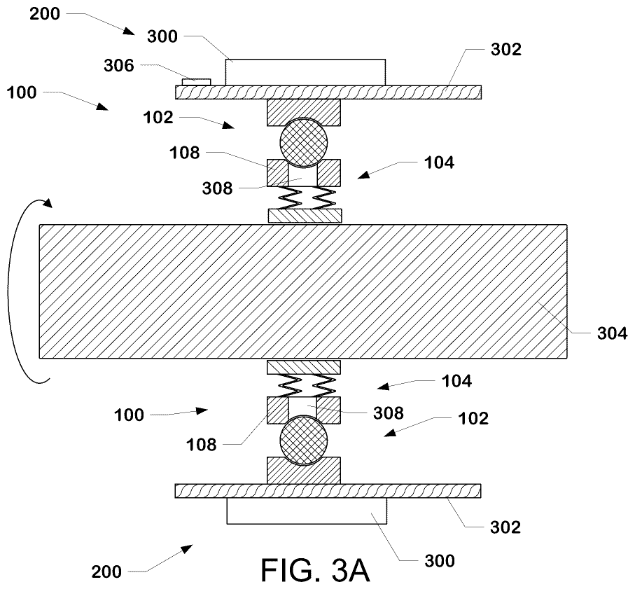

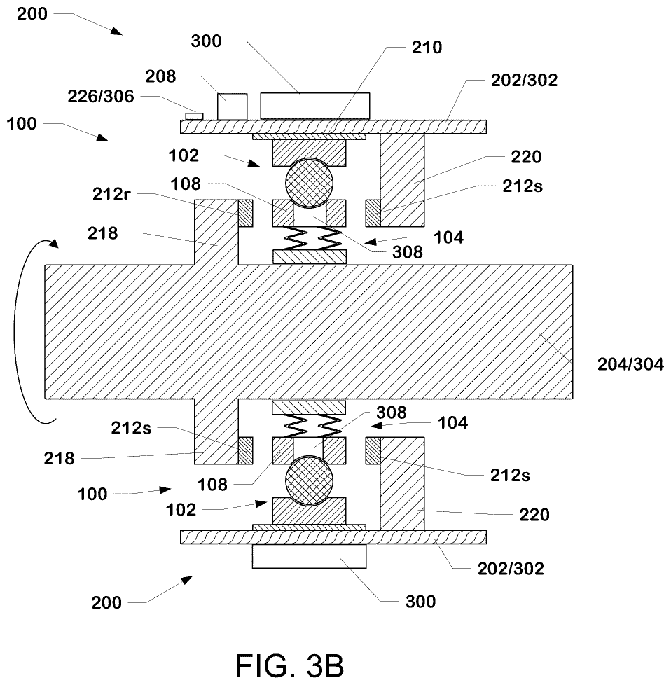

In examples, in place of or in addition to the displacer as described with reference to FIGS. 2A-2J, the bearing engagement system 200 may be configured to apply a magnetic torque to the inner radial bearing 104. In examples, a radial bearing 100 may be positioned to functionally couple a rotor 204 to a stator 202 as shown in FIG. 3A. In examples, the arrangement of radial bearing 100 with respect to rotor 204 and stator 202 may be as previously described with reference to FIG. 2A. In examples, where magnetic torque applied as described herein is employed as the only means to affect the operation of radial bearing 100 or portions thereof as also described herein, radial bearing 100 and/or outer radial bearing 102 and/or the housing of radial bearing 100 may be directly fixed to a stator via one or more fasteners, welding, or any combination thereof as previously described.

In examples, the bearing engagement system 200 may include one or more electromagnets 300 to form a magnetic field configured to apply a magnetic torque to the inner radial bearing 104. In examples, bearing engagement system 200 may control the operation of radial bearing 100 by the application of such torque. In examples, bearing engagement system 200 may include one or more electromagnets 300. In examples, an electromagnet 300 may include a coil or winding of electrically conducting material. In examples, electromagnet 300 may include an electromagnetic coil or winding. In examples, one or more electromagnets 300 may be provided in the stator 302, rotor 304, or both. In examples, one or more magnets or poles 308 may be provided in and/or built into the radial bearing 100, inner radial bearing 104, middle ring 108, and/or inner ring 110. In examples, as illustrated in FIG. 3A, one or more electromagnets 300 may be provided on the stator 302 and one or more magnets or poles 308 may be provided in middle ring 108.

In examples, bearing engagement system 200, via one or more electromagnets 300, may generate a magnetic field around at least a portion of radial bearing 100. In examples, the magnetic field may extend to at least a portion of the bearing system where the middle ring 108 or inner ring 110 are located. In examples, bearing engagement system 200 via the one or more electromagnets 300 may be configured to be able to control the magnetic field. In examples, control of a magnetic field may include turning it on and off, modifying magnitude, modifying direction, or any combination thereof. In so doing, it may be possible to apply and/or induce a torque to radial bearing 100, inner radial bearing 104, middle ring 108, and/or inner ring 110. In examples, the torque may be generated by the magnetic field opposing eddy currents that may be created by the rotating radial bearing 100, inner radial bearing 104, middle ring 108, and/or inner ring 110. By applying the torque via a magnetic field, the bearing engagement system 200 may thus control and/or affect the rotation of radial bearing 100, inner radial bearing 104, middle ring 108, and/or inner ring 110. In examples, where the magnets or poles 308 are provided in middle ring 108, the application of the torque via magnetic field would affect the rotation of middle ring 108. In examples, rotation of the middle ring 108 may affect rotation of inner radial bearing 104 and/or inner ring 110. In examples, the application of the torque via a magnetic field can lead to slowing and/or stopping the rotation of radial bearing 100, inner radial bearing 104, middle ring 108, and/or inner ring 110. In this manner, the bearing engagement system 200 may switch between the engagement of the outer radial bearing 102 and inner radial bearing 104.

In examples, control of the electromagnetic field via electromagnets 300 and thus application of the torque may be used to allow for rotation of inner radial bearing 104, middle ring 108, and/or inner ring 110, induce rotation of inner radial bearing 104, middle ring 108, and/or inner ring 110, and/or impede rotation of inner radial bearing 104, middle ring 108, and/or inner ring 110. In examples, inducing rotation of inner radial bearing 104, middle ring 108, and/or inner ring 110 may include inducing rotation in the same direction as the rotor 204 or in the opposite direction of the rotor 204. In examples, inducing rotation in the opposite direction of rotor 204 may achieve an artificially high relative rotational speed of the air foil and/or of inner radial bearing 104, middle ring 108, and/or inner ring 110 with respect to the rotor 204 to assist achieving lift off speed and creating an air or other gas film between the inner ring 110 and the rotor 204. In examples, once the rotational speed of the rotor 204 relative the inner radial bearing 104, middle ring 108, and/or inner ring 110 reaches or surpasses a threshold, the inner radial bearing 104, middle ring 108, and/or inner ring 110 may be caused to come to a stop by control of the magnetic field allowing for an air or other gas film between the rotor 204 and inner ring 110 to be formed and thus letting the rotor to continue to freely rotate while remaining coupled to the stator 202.

For example, as previously described, a dual bearing may include an outer radial bearing 102 such as a roller and/or ball bearing and an inner radial bearing 104 such as an air foil bearing. In examples, as the rotor commences to rotate, the engagement system may control one or more electromagnets 300, for example in the off state, thereby not forming a magnetic field. In this state, the inner ring 110 may be in contact with the surface of the rotor. In this state, the inner radial bearing 104 may rotate with the rotor. In this state, in examples, the outer radial bearing 102 may be engaged and allow for the coupling of the rotor 204 to the stator 202 while accommodating the rotation of the rotor 204 via the roller and/or ball bearing of outer radial bearing 102. In examples, status of radial bearing 100 or of a portion thereof, for example, of an air foil bearing if one is present, and/or of rotational speed of rotor 204, the one or more electromagnets 300 may be engaged to switch between the outer radial bearing 102 and the inner radial bearing 104. In examples, the status of radial bearing 100 or of a portion thereof and/or the rotational speed of rotor 204 may be detected as previously described. For example, as the rotation of rotor 204 and/or of inner radial bearing 104, or the rotational speed of the rotor 204 relative the inner radial bearing 104, reaches or goes above a threshold, the air foil bearing may be engaged to allow for a film of air to form between the surface of rotor 204 and the inner ring 110 of radial bearing 100 to lower the friction radial bearing 100 imposes on the rotor 204. In examples, to engage of the air foil the bearing engagement system 200 may switch from engaging the outer radial bearing 102 to engaging the inner radial bearing 104. As indicated earlier, one or more controllers 306 may be used to effectuate the switch based on sensor information and/or a set of stored and/or manually entered instructions.

In examples, the one or more controllers 306 may control and/or activate and deactivate the one or more electromagnets 300. In examples, the bearing engagement system 200 may power the one or more electromagnets 300 to control and/or generate a magnetic field. In so doing, the magnetic field can affect the one or more magnets or poles 308 and thus result in a torque being applied to radial bearing 100, middle ring 108, inner radial bearing 104, inner ring 110, or any combination thereof. In applying such a torque, the rotation of inner radial bearing 104, middle ring 108, and/or inner ring 110 may be slowed and/or stopped. In this state, the inner radial bearing 104, middle ring 108, and/or inner ring 110 may be maintained substantially still. For purposes of this disclosure, substantially still means no functionally relevant movement from a fixed position. As inner radial bearing 104 comes to a stop, it can be engaged due to the air foil design and allow for a film of air to form between inner radial bearing 104 and rotor, thus allowing the rotor to freely rotate while remaining coupled to the stator. In examples, as the inner radial bearing 104 and/or middle ring 108 are maintained substantially still and/or in a static state the operation of the outer radial bearing 102 will be disengaged as it no longer accommodates for the rotation. In examples, when the engagement of the outer radial bearing 102 is again desired, the electromagnets can be turned off, thereby eliminating the magnetic field and allowing the middle ring 108 and/or inner radial bearing 104 to again rotate with the rotor.

The above example referencing FIG. 3A describes a system in which a radial bearing 100 may include a hybrid dual bearing with an inner radial bearing 104 including an air foil bearing and an outer radial bearing 102 including a roller and/or ball bearing. As previously discussed, this is just an example. In examples, the radial bearing 100 may include a dual bearing with the same or different types of bearing for inner and outer bearings. In examples, the bearing 100 may include a ball or roller bearing as the inner bearing 104. In examples, the application of the magnetic field may be used to switch between engagement of the outer radial bearing 102 and the inner radial bearing 104 for any desired reason. For example, it may be used to switch to a bearing to be used as a backup.

In examples, the bearing engagement system 200 may include a combination of a displacer and the application of a magnetic field. For example, as illustrated in FIG. 3B, the bearing engagement system 200 may include a combination of the lateral displacement and/or linear translation of the radial bearing 100 or subcomponents thereof as described with reference to FIGS. 2A-2C, and the application of a magnetic field as described with reference to FIG. 3A. In other examples, the bearing engagement system 200 may include a combination of the displacement of one or more interface elements as described with reference to FIGS. 2D-2J, and the application of a magnetic field as described with reference to FIG. 3A. In examples, the bearing engagement system 200 may include a combination of the lateral displacement and/or linear translation of the radial bearing 100 or subcomponents thereof as described with reference to FIGS. 2A-2C, the displacement of one or more interface elements as described with reference to FIGS. 2D-2J, and the application of a magnetic field as described with reference to FIG. 3A.

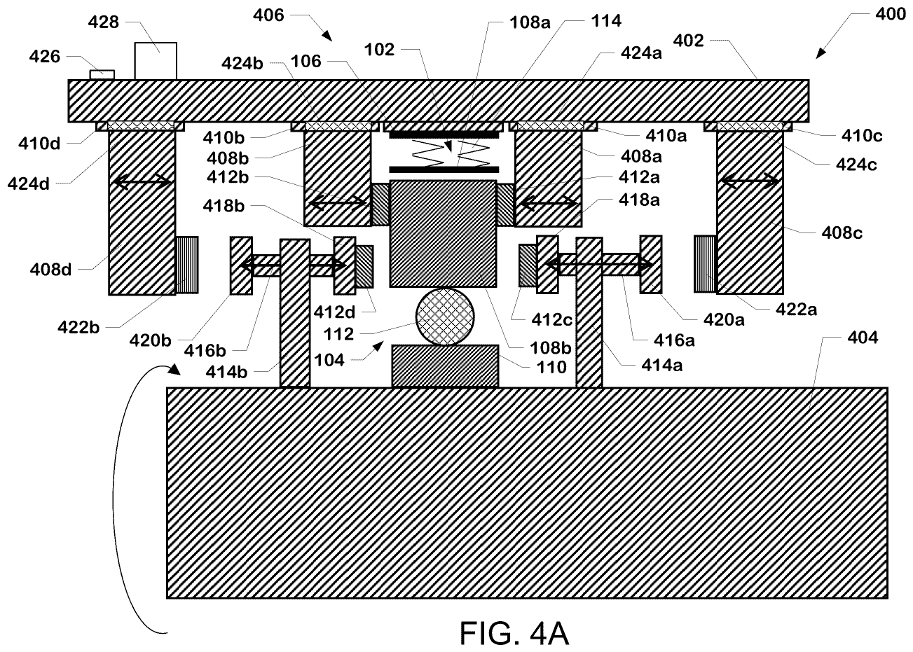

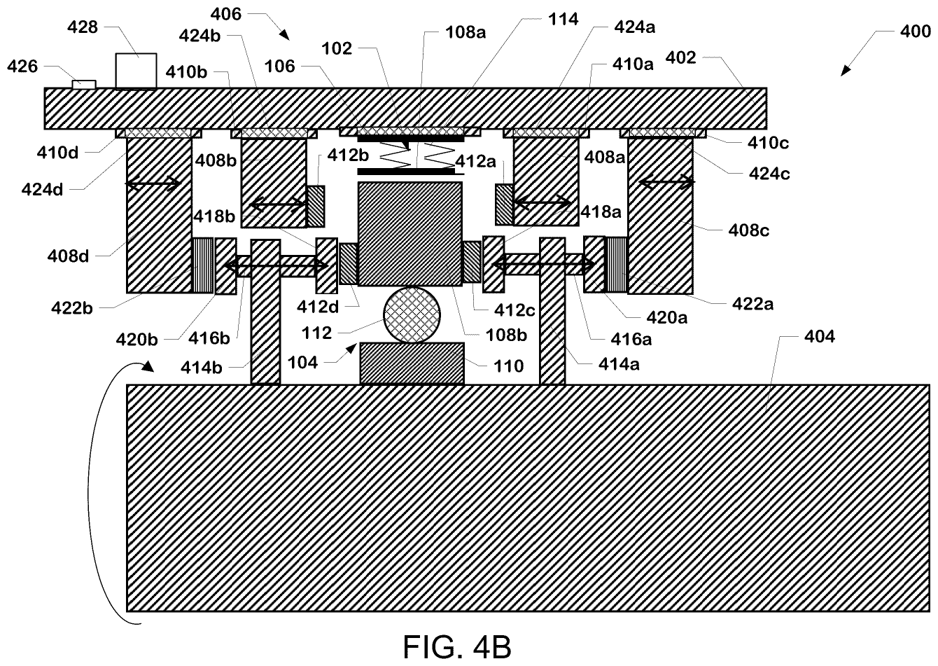

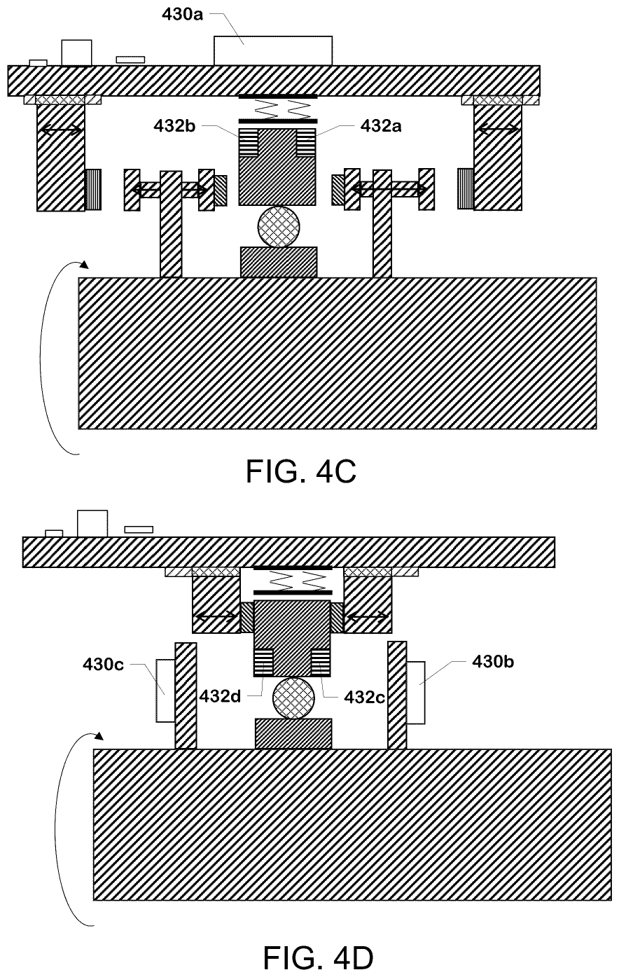

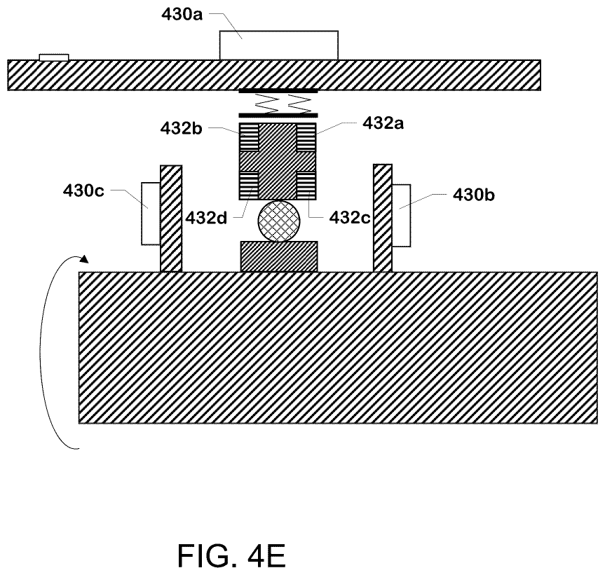

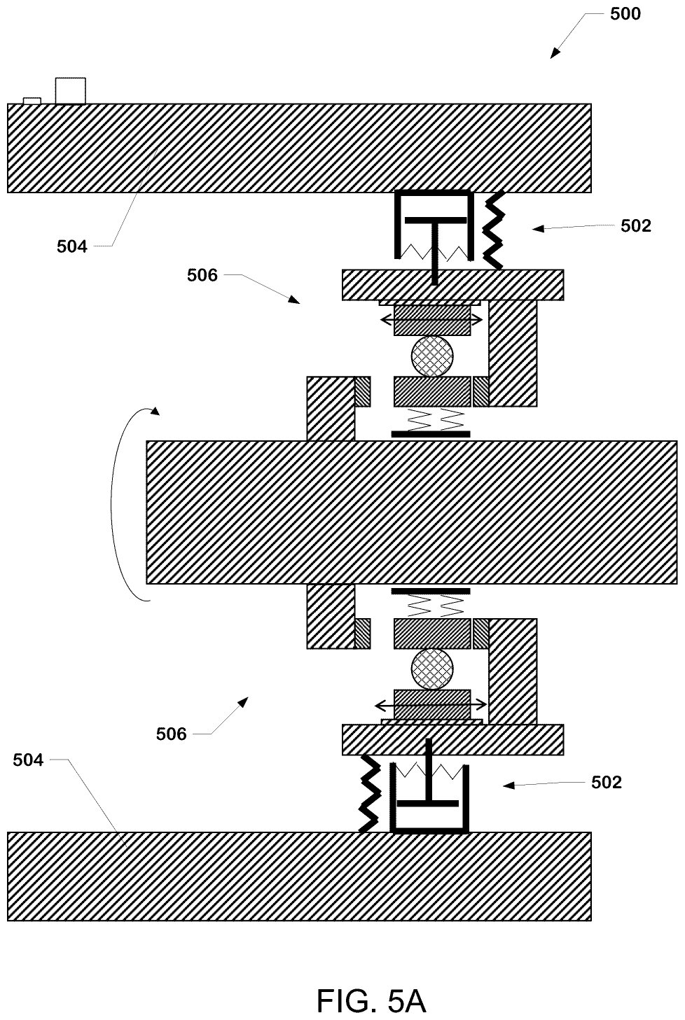

FIGS. 4A and 4B illustrate examples of an implementation of a bearing system including a radial bearing 100 combined with a bearing engagement system 400 as similarly described with reference to FIG. 2E. FIGS. 4A and 4B illustrate that the bearing engagement system may include more than two stator protrusions to perform the switch between the inner radial bearing 104 and outer radial bearing 102 of radial bearing 100. FIGS. 4A and 4B also illustrate an example in which the outer radial bearing 102 may include a foil bearing instead of the inner radial bearing 104.

The implementation as illustrated in FIGS. 4A and 4B is conceptually and functionally similar to what has already been described with reference to FIGS. 2A-2J, 3A, and 3B in that the bearing engagement system 400 is configured to switch operation between the inner radial bearing 104 and the outer radial bearing 102 depending on the rotational speed or status of the rotor. As previously described with reference to FIGS. 2A-2J, and particularly with reference to FIG. 2E, the switch may be carried out via one or more actuators. For illustration purposes only, to ensure that the elements can be better shown and understood, FIGS. 4A and 4B illustrate the components of a bearing engagement system 400 and of radial bearing 100 on only one side of the rotor. It is to be understood that radial bearing 100 surrounds the rotor as intended and illustrated when describing the invention with reference to FIGS. 2A-2C, 3A, and 3B. It is also to be understood that the bearing engagement system 400 can be provided on either or both sides of the rotor and/or surrounding the rotor also as intended when describing the examples with reference to FIGS. 2A-2J, 3A, and 3B.

FIGS. 4A and 4B illustrate an example in which a stator 402 and a rotor 404 with an intervening radial bearing 100. In examples, radial bearing 100 is configured to functionally couple stator 402 to rotor 404. As shown, radial bearing 100 in this example includes an outer radial bearing 102 that includes a gas bearing, exemplified as a foil bearing, e.g. an air foil bearing, and an inner 104 bearing that includes a roller or ball bearing. As shown in FIG. 4A, bearing engagement system 400 may include one or more displacers 406. In examples, a displacer 406 may be configured to functionally connect and/or couple one or more stator protrusions 408 (e.g. 408a, 408b, 408c, and 408d) to the stator 402.

In the example shown in FIGS. 4A and 4B, radial bearing 100 may have an outer ring 106 fixed to the stator 402 and an inner ring 110 fixed to the rotor 404. In examples, as previously described, when a foil bearing is used as the outer radial bearing 102, the top foil of the foil bearing may surround the outer ring of the inner radial bearing 104. In examples, the middle ring 108 as shown may include concentric rings 108a and 108b. In examples, concentric middle ring 108a may be the top foil of the foil bearing used as outer radial bearing 102. In examples, the concentric middle ring 108b may be the outer ring of the inner radial bearing 104. In the illustrated example, the inner ring is shown as a roller or ball bearing.

In examples, the one or more stator protrusions 408 functionally connected and/or coupled to the stator 402 may be configured to translate linearly via one or more linear actuators 424 (e.g. 424a, 424b, 424c, and 424d) and respective tracks 410 (e.g. 410a, 410b, 410c, and 410d). In examples, a single continuous track 410 may be provided to accommodate for the translation of each of the one or more linear actuators 424. In examples, the one or more linear actuators 424 may be controlled by one or more controllers 426. In examples a controller 426 may be as similarly described controller 226. In examples, the one or more linear actuators 424 may be powered by one or more motors 428. In examples a motor 428 may be as similarly described motor 208. In examples, the one or more stator protrusions 408 may include a first bearing direct engagement stator protrusion 408a and a second bearing direct engagement stator protrusion 408b. In examples, the one or more stator protrusions 408 may include a first thrust bearing engagement stator protrusion 408c and a second thrust bearing engagement stator protrusion 408d. As previously described, a direct engagement stator protrusion may include an interface element at an opposite end from the end functionally connected and/or coupled to the stator, the interface element arranged to face the radial bearing 100. In examples, as also discussed earlier, a thrust bearing engagement stator protrusion may include a thrust bearing at an opposite end from the end functionally connected and/or coupled to the stator. In examples, the one or more stator protrusions 408 may be able to translate linearly towards and away from radial bearing 100.

In examples, by translating towards radial bearing 100, first and second bearing direct engagement stator protrusion 408a and 408b can cause a first and second interface elements 412a and 412b to contact the inner radial bearing 104 and/or at least a portion of middle ring 108 of radial bearing 100. In examples, interface elements 412a and 412b may contact the concentric middle ring 108b that includes the outer ring of the inner radial bearing 104. In examples, when interface elements 412a and 412b contact the inner radial bearing 104 and/or at least a portion of middle ring 108 such as concentric middle ring 108b, they prevent concentric middle ring 108b, i.e. the outer ring of the inner radial bearing 104, from rotating thereby disengaging the outer radial bearing 102. In examples, by translating away from radial bearing 100, first and second bearing direct engagement stator protrusion 408a and 408b can cause a first and second interface elements 412a and 412b to distance, separate, or move away from the inner radial bearing 104 and/or at least a portion of middle ring 108 such as concentric middle ring 108b, of radial bearing 100. In examples, when interface elements 412a and 412b do not contact the inner radial bearing 104 and/or at least a portion of middle ring 108 such as concentric middle ring 108b, they allow concentric middle ring 108b, i.e. the outer ring of the inner radial bearing 104, to rotate thereby engaging the outer radial bearing 102. In examples, as the outer ring of inner radial bearing 104 rotates it can cause a film of air or other gas to form between it and the top foil of the foil bearing of outer radial bearing 102. This can allow for rotation with decreased or no friction.

In examples, when interface elements 412a and 412b do not contact the inner radial bearing 104 and/or at least a portion of middle ring 108 such as concentric middle ring 108b, the inner radial bearing 104 and/or at least a portion of middle ring 108 such as concentric middle ring 108b may be contacted by third and four interface elements 412c and 412d that may cause rotation of the inner radial bearing 104 and/or at least a portion of middle ring 108 such as concentric middle ring 108b with the rotor 404.

In examples, the rotor 404 may include one or more rotor protrusions 414 (e.g. 414a and 414b). In examples, the one or more rotor protrusions 414 are fixed connected to the rotor 404. In examples, each rotor protrusion 414 may include a sliding element 416. In examples, sliding element 416 may include two press elements 418 and 420 at respective opposite ends with one press element 418 facing radial bearing 100 and the other press element 420 facing away from radial bearing 100. In examples, press element 418 facing radial bearing 100 may include an interface element 412. In examples, the press element 420 facing away from radial bearing 100 may face a thrust bearing 422 provided on a thrust bearing engagement stator protrusion 408.

In examples, as shown in FIGS. 4A and 4B, a first rotor protrusion 414a may include a first sliding element 416a having a first press element 418a facing radial bearing 100 and second press element 420a. In examples, first press element 418a may include a third interface element 412c. In examples, second press element 420a may be arranged to face a first thrust bearing 422a provided on a first thrust bearing engagement stator protrusion 408c. In examples, as also shown in FIGS. 4A and 4B, a second rotor protrusion 414b may include a second sliding element 416b having a first press element 418b facing radial bearing 100 and second press element 420b. In examples, first press element 418b may include a fourth interface element 412d. In examples, second press element 420b may be arranged to face a second thrust bearing 422b provided on a second thrust bearing engagement stator protrusion 408d.

In examples, as shown in FIGS. 4A and 4B, a direct engagement stator protrusion, a thrust bearing engagement stator protrusion, and a rotor protrusion may be on one side of radial bearing 100 with the other direct engagement stator protrusion, thrust bearing engagement stator protrusion, and rotor protrusion on the other, opposite side, of radial bearing 100. In this manner the interface elements 412 may contact the inner radial bearing 104 and/or middle ring 108 of radial bearing 100 at opposite side ends. This may provide a more reliable and/or effective contact.

In examples, as the first thrust bearing engagement stator protrusion 408c and the second thrust bearing engagement stator protrusion 408d translate towards radial bearing 100, they cause translation of respective first and second thrust bearings 422a and 422b towards respective second press element 420a and 420b of respective first and second sliding elements 416a and 416b of respective first and second rotor protrusions 414a and 414b. As each thrust bearing 422 presses against the respective second press element 420 it may cause the respective sliding element 416 to slide towards radial bearing 100. As the sliding element 416 slides towards radial bearing 100, it causes translation of the respective first press element 418 and respective interface element 412 to translate towards radial bearing 100. In doing so, the interface element 412 on the first press element 418 can be caused to contact or press against inner radial bearing 104 and/or a portion of middle ring 108, such as concentric middle ring 108b, of radial bearing 100. This in turn may result in the outer ring of the inner radial bearing 104 to rotate with the rotor 404 and thus effectively disengaging inner radial bearing 104. In examples, as the first thrust bearing engagement stator protrusion 408c and the second thrust bearing engagement stator protrusion 408d translate away from radial bearing 100, they cause translation of respective first and second thrust bearings 422a and 422b away from respective second press element 420a and 420b of respective first and second sliding elements 416a and 416b of respective first and second rotor protrusions 414a and 414b. As each thrust bearing 422 moves away from the respective second press element 420 it causes the respective sliding element 416 to slide away from radial bearing 100 and return to its initial position. In examples, the sliding element 416 may spring-back into position. As the sliding element 416 slides away from radial bearing 100, it causes translation of respective first press element 418 and respective interface element 412 to translate away from radial bearing 100. In doing so, the interface element 412 on the first press element 418 can be caused to separate or move away from inner radial bearing 104 and/or a portion of middle ring 108, such as concentric middle ring 108b, of radial bearing 100. This in turn may result in the outer ring of the inner radial bearing 104 to not be decoupled from the rotor 404 thus allowing the inner radial bearing 104 to be engaged and operate.

FIG. 4A illustrates the described system when the inner radial bearing 104 is engaged and outer radial bearing 102 disengaged, i.e. when the inner radial bearing 104 and/or middle ring 108, or concentric middle ring 108b, is contacted only by first and second interface elements 412a and 412b by translating first and second bearing direct engagement stator protrusion 408a and 408b towards radial bearing 100, and translating the first and second thrust bearing engagement stator protrusion 408c and 408d away from radial bearing 100. In this manner the load of the rotor 404 may be carried by the inner radial bearing 104. In the illustrated examples, inner radial bearing 104 may be a roller or ball bearing which can provide greater support when the rotor 404 rotates at lower speed.

In examples, as the rotor 404 rotational speed increases, it may be desirable to disengage inner radial bearing 104 and disengage outer radial bearing 102 to allow for higher rotational speed and/or lower the friction and/or dampen vibration. In such a case, as shown in FIG. 4B the stator protrusions 408 may be translated so that the first and second bearing direct engagement stator protrusion 408a and 408b translate away from radial bearing 100, while first and second thrust bearing engagement stator protrusion 408c and 408d translate toward radial bearing 100. In this manner, as discussed earlier, third and fourth interface elements 412c and 412d contact the inner radial bearing 104 and/or middle ring 108, or concentric middle ring 108b. In this configuration, the inner radial bearing 104 is disengaged as its outer ring (i.e. concentric middle ring 108b) is coupled to rotor 404. Coupling the outer ring of inner radial bearing 104 and/or concentric middle ring 108b with the rotor 404 causes the outer ring of inner radial bearing 104 and/or concentric middle ring 108b to rotate with the rotor 404. This rotation may cause a film of air or other gas to form between the outer ring of inner radial bearing 104 and/or concentric middle ring 108b and the top foil of the foil bearing of outer radial bearing 102. This allows for the rotation of inner radial bearing 104 and/or concentric middle ring 108b and consequently of the coupled rotor 404 to rotate with reduced or no friction and/or with dampened vibration.

In examples, it may be desirable to provide a means of dampening vibration independent of the operation or nature of radial bearing 100. In examples, any suitable vibration dampening system that can be used with a bearing system may be used with the system described herein. In examples, the system described herein may be encased by a vibration dampener housing and provided with means to dampen vibration located between the stator and the bearing engagement system.

FIG. 4C-4D illustrate examples of the system described with reference to FIGS. 4A and 4B with one or more electromagnets 430 (e.g. 430a, 430b, 430c etc. . . . ) provided on the stator 402 and/or rotor 404 and one or more magnets or poles 432 provided in and/or built into the radial bearing 100, inner radial bearing 104, middle ring 108, and/or inner ring 110 as previously described with reference to FIG. 3A. In examples, as illustrated in FIGS. 4C-4D one or more electromagnets 430 and magnets or poles 432 (e.g. 432a, 432b, 432c, and 432d) combinations may be used to replace or using together with one or more translating protrusions described with reference to FIGS. 4A and 4B. In examples, operation of the radial bearing 100 may be affected by an electromagnet 430 in the same manner described with reference to FIG. 3A.

In examples, FIG. 4C illustrates how one or more electromagnets 430a provided on stator 402 and one or more magnets or poles 432a and 432b provided in middle ring 108 may be used in place or in addition to first bearing direct engagement stator protrusion 408a, a second bearing direct engagement stator protrusion 408b, and respective interface elements 412.

FIG. 4D illustrates an example of how one or more electromagnets 430b and 430c provided on rotor protrusions 414a and 414b and one or more magnets or poles 432c and 432d provided in middle ring 108 may be used in place or in addition to first thrust bearing engagement stator protrusion 408c, second thrust bearing engagement stator protrusion 408d, and respective sliding elements 416, thrust bearings 422, and interface elements 412.

FIG. 4E illustrates an example of how one or more electromagnets 430a provided on the stator 402, one or more electromagnets 430b and 430c provided on rotor protrusions 414a and 414b, and one or more magnets or poles 432a, 432b, 432c, and 432d provided in middle ring 108, may be used in place or in addition to first bearing direct engagement stator protrusion 408a, a second bearing direct engagement stator protrusion 408b, (first thrust bearing engagement stator protrusion 408c, second thrust bearing engagement stator protrusion 408d, and respective sliding elements 416, thrust bearings 422, and interface elements 412.

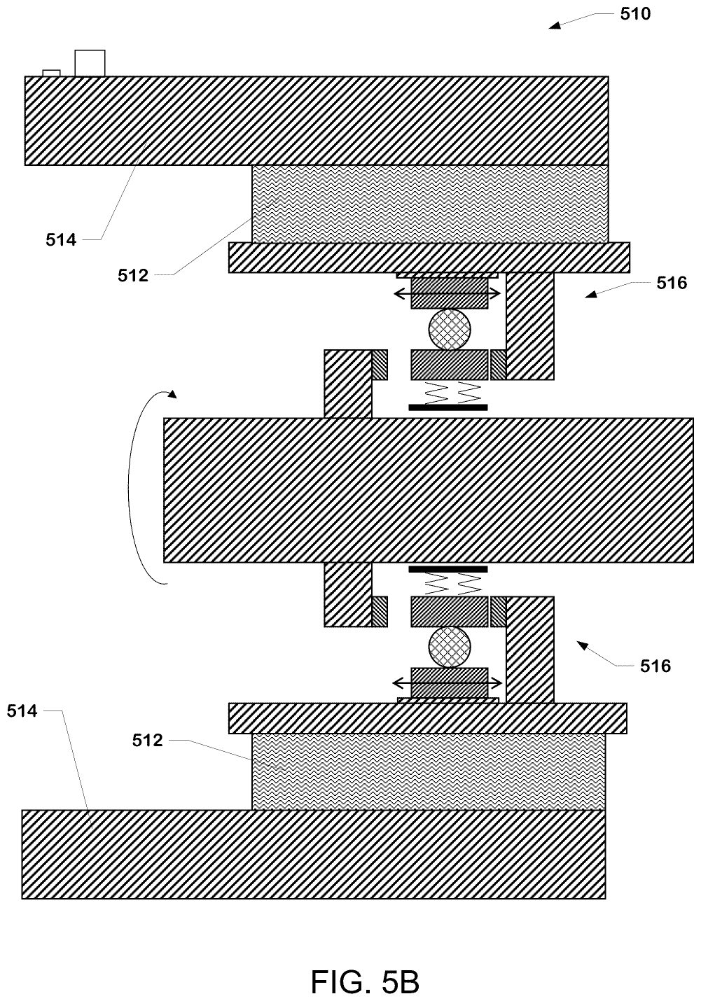

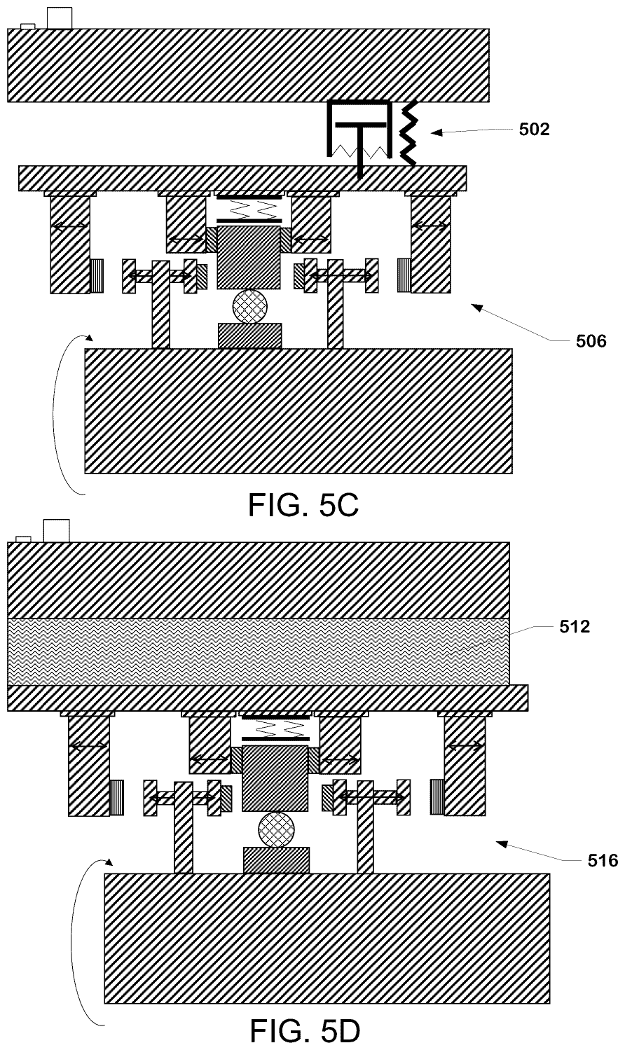

FIGS. 5A and 5B illustrate examples of a vibration dampening system 500 that may be used together with the system described herein. These are non-limiting examples, as other vibration dampening systems may also be employed. In examples, a vibration dampening system may include a mechanical system, a hydraulic system, an electromagnetic dampener, or a combination thereof. FIG. 5A illustrates an example of a mechanical vibration dampening system. In examples, as shown, a piston dampener 502 may be provided between a vibration dampener housing 504 and the bearing engagement system 506. FIG. 5B illustrates an example of a hydraulic vibration dampening system 510. In examples, as shown, a functional fluid 512 such as an oil may be provided between a vibration dampener housing 514 and the bearing engagement system 516. In examples, providing the vibration dampening system does not affect the operation or design of the bearing engagement system as described herein. FIGS. 5C and 5D illustrate examples of a vibration dampening system as combined with the examples of bearing system described with reference to FIG. 4A.

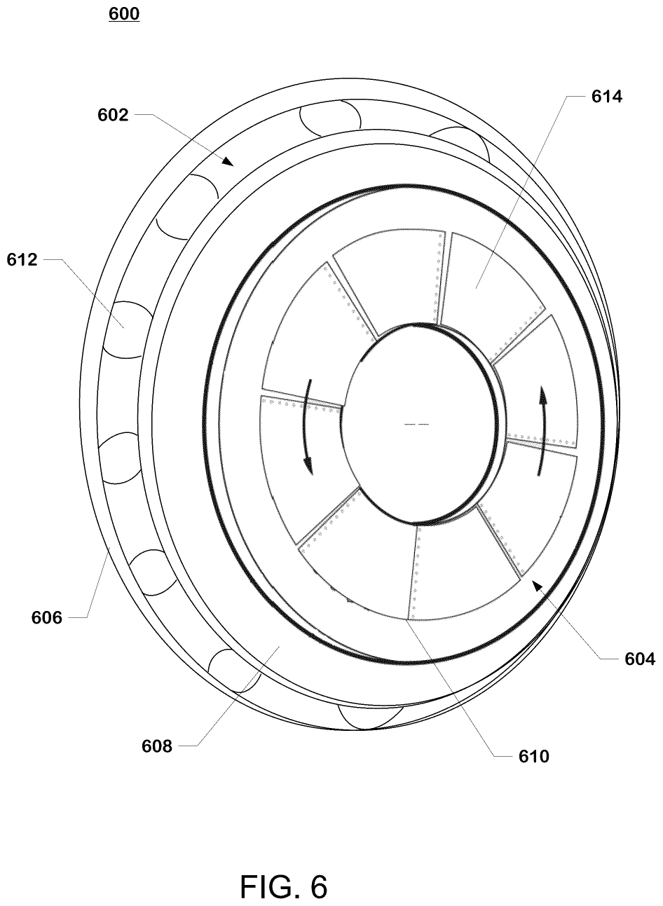

FIG. 6 illustrates an example of an axial bearing 600. In examples, axial bearing 600 may include a dual bearing. In examples, the dual bearing may include an outer axial bearing 602 and an inner axial bearing 604. In examples, the outer axial bearing 602 and the inner axial bearing 604 can be side-by-side. In examples, inner axial bearing 604 may be provided over the functional surface of the outer axial bearing 602. In examples, the axial bearing 600 may include an outer plate 606. In examples, the axial radial bearing 100 may include a middle plate 608. In examples, the axial bearing 600 may include an inner surface 610. In examples, the outer plate 606 and middle plate 608 may define and be part of the outer axial bearing 602. In examples, the middle plate 608 and the inner surface 610 may define and be part of the inner axial bearing 604. In examples, middle plate 608 may be part of the outer axial bearing 602 and of the inner axial bearing 604. In examples, middle plate 608 may be the inner surface of the outer axial bearing 602 and the back plate or outer plate of the inner axial bearing 604. In examples, in axial bearing 600 if outer plate 606 is maintained at a static state, rotation of middle plate 608 may cause engagement of outer axial bearing 602.

In examples, the outer axial bearing 602 and the inner axial bearing 604 can be independently selected from any type of axial bearing. In examples, the outer axial bearing 602 and the inner axial bearing 604 may be independently selected from a roller axial bearing, a ball axial bearing, a gas bearing such as a axial leaf-type bearing, a bump-type or wire mesh axial foil bearing, tilting pads axial bearing, a lubricated axial bearing, a non-lubricated axial bearing, or any combination thereof. The term “lubricated axial bearing” as used herein refers to axial bearings that use a lubricant other than a gas or air, for example, axial bearings that use a functional fluid such as oil or other liquid, solid, or other non-gaseous materials. In examples, bearing 600 may be free of lubricant both in the outer radial bearing 602 and in the inner radial bearing 604. In examples, the axial bearing 600 can include a dual axial bearing having a roller axial bearing or a ball axial bearing as the outer axial bearing 602 and a gas bearing such as a axial leaf-type bearing, e.g. thrust bearing, as the inner axial bearing 604 as, for example, shown in FIG. 6. In examples, the outer axial bearing 602 may be a lubricated or unlubricated axial bearing. In examples (not shown), the outer axial bearing 602 may be a gas bearing such as a axial leaf-type bearing, e.g. a thrust bearing, and the inner axial bearing 604 may be a roller axial bearing or ball axial bearing. In examples, the inner axial bearing 604 may be a lubricated or unlubricated axial bearing. In examples, the outer axial bearing 602 may be the same or different from the inner axial bearing 604.

In examples, the axial bearing 600 may include a dual axial bearing that can take advantage of being able to switch operation between the outer axial bearing 602 and the inner axial bearing 604. In examples, a dual axial bearing may be used to provide a back-up function. For example, if the outer axial bearing 602 malfunctions, the inner axial bearing 604 may be engaged in its place or vice-versa.

In examples, axial bearing 600 may include a hybrid dual axial bearing where the outer axial bearing 602 is different from the inner axial bearing 604. In examples, a hybrid system may provide the advantage of being able to benefit from the features of the two different axial bearings by switching between them when most desirable. In examples, outer axial bearing 602 may be a roller or ball axial bearing and inner axial bearing 604 may be a gas bearing such as a axial leaf-type bearing, e.g. thrust bearing, or a foil bearing such as a bump-type or a wire mesh axial foil bearing. In examples, outer axial bearing 602 may be a gas bearing such as a axial leaf-type bearing, e.g. a thrust bearing, or a foil bearing such as a bump-type or wire mesh axial foil bearing and inner axial bearing 604 may be a roller or ball axial bearing. In either of such hybrid configurations, it may be possible to rely on one axial bearing below a rotational speed of the rotor and to rely on the other axial bearing to reduce friction, provide cushioning, and/or dampen vibration when the rotational speed has surpassed a threshold. For example, at a start of a rotation of a rotor, the rotational speed may not be sufficiently high to generate an air or gas film with the gas bearing. At this stage it may thus be desirable to engage the roller axial bearing or ball axial bearing by enabling the operation of the axial bearing 600 as the rolling elements 612 as this can aid in carrying the load until the gas bearing is ready to be engaged. As the rotational speed of the rotor increases beyond a threshold, the gas bearing such as the axial leaf-type bearing or an axial foil bearing may be engaged to allow for a film of air or gas to form between the rotor and the inner plate including, for example, the leaf foils or top foil of the axial bearing 600. By engaging the gas bearing, the rotor can achieve high rotational speed. In examples, this may be especially true where axial bearing 600 is lubricant free. In examples, engagement of the gas bearing may also lead to lower or no friction rotation while maintaining the axial bearing operation. In examples, an axial foil bearing may include a wire mesh axial foil bearing that when engaged may allow for lower friction, cushioning, and/or vibration damping. In examples, these advantages can be accomplished by switching the operation of the axial bearing 600 from the outer axial bearing 602 to the inner axial bearing 604 or from inner axial bearing 604 to outer axial bearing 602 as similarly described with reference to radial bearing 100.

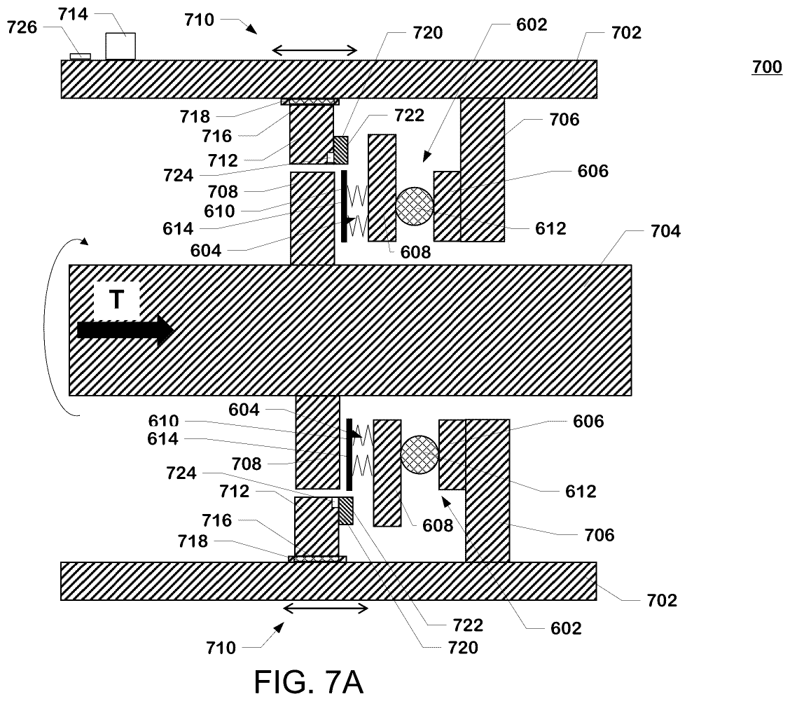

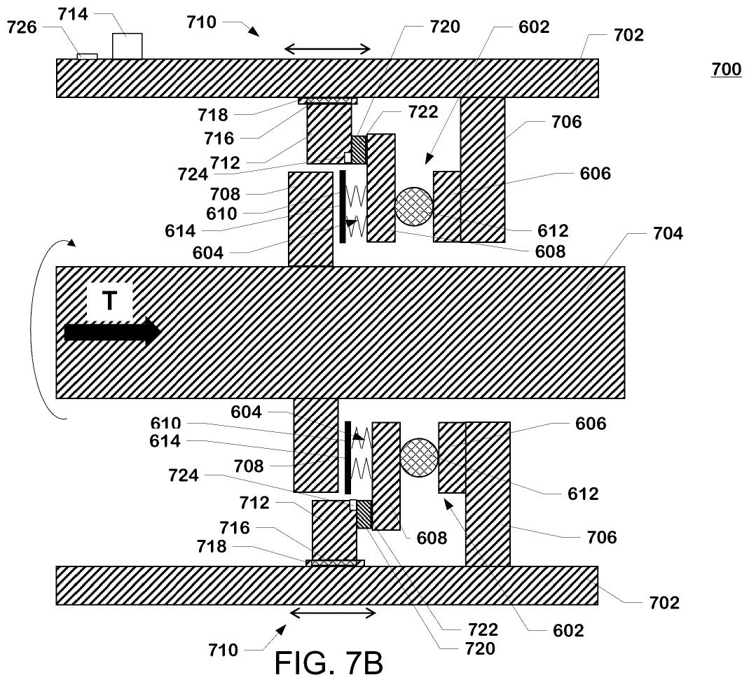

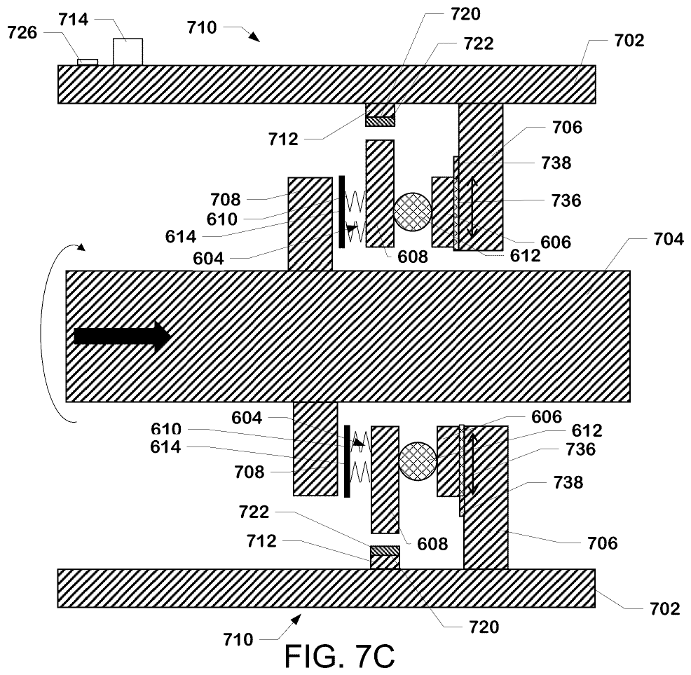

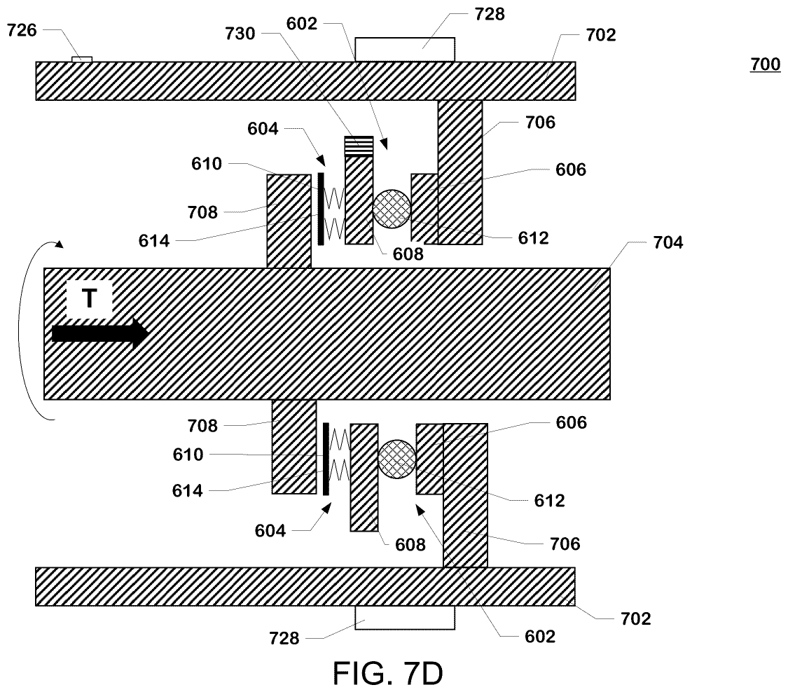

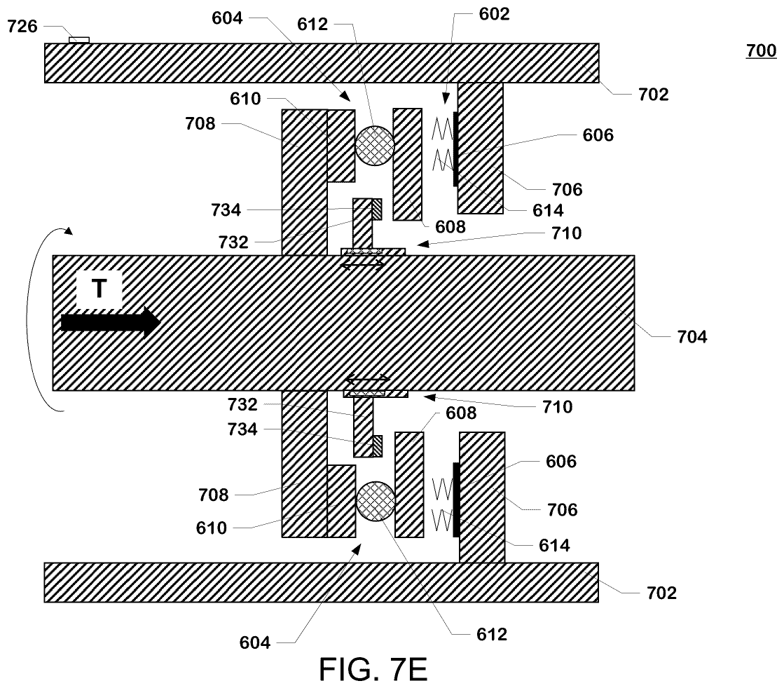

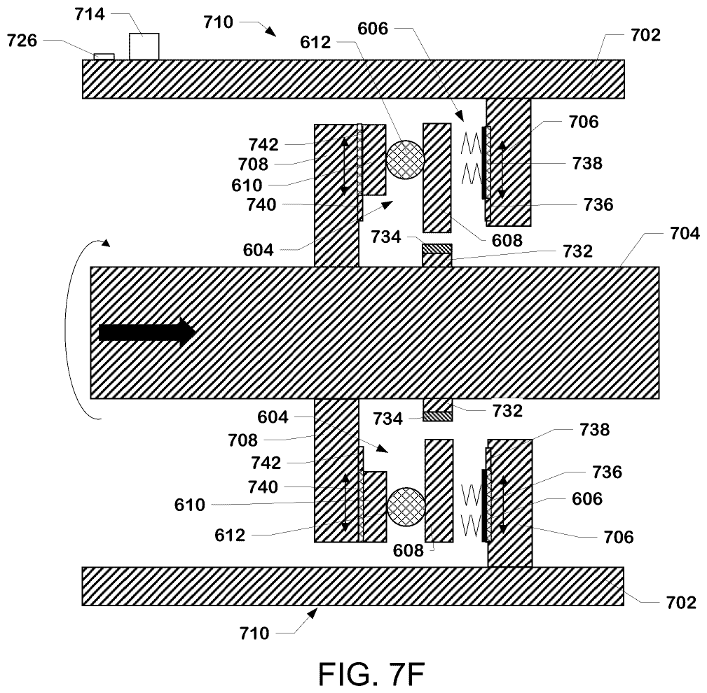

The following description referencing FIGS. 7A and 7B provides examples of a bearing system employing an axial bearing 600 that includes a dual bearing with an outer axial bearing 602 that is a roller bearing or ball bearing and an inner axial bearing 604 that is a gas bearing exemplified as a leaf-type bearing such as a thrust bearing. These are only an example as other types of gas bearings and other types of dual bearing, hybrid or not, may also be equally implemented.

In examples, the bearing system as described herein may include an axial bearing 600 combined with a bearing engagement system 700. In examples, the bearing engagement system 700 may be configured to control the operation of axial bearing 600. In examples, the bearing engagement system 700 may be configured to effectuate a switch between operation of the outer axial bearing 602 and the inner axial bearing 604 to thereby take advantage of the dual bearing. In examples, the bearing engagement system 700 may be configured to control a rotation of the inner axial bearing 604, outer axial bearing 602, middle plate 608, inner surface 610, or any combination thereof. In examples, engagement system 700 may be configured to control a rotation of the inner axial bearing 604, middle plate 608, and/or inner surface 610 relative to outer axial bearing 602 and/or outer plate 606.

FIG. 7A-7C illustrates a cross-sectional diagram of an example of an axial bearing 600 together with an example of a bearing engagement system 700. In the examples, axial bearing 600 may include a hybrid dual bearing, and particularly a hybrid leaf-type bearing with an outer roller bearing and/or ball bearing adjoined thereto an inner leaf-type bearing. As shown, an example cross section of an axial bearing 600, including outer plate 606, rolling element 612, middle plate 608, leaf petals 614, and inner surface 610, may be positioned between a stator 702 and a rotor 704. In examples, as shown, the outer axial bearing 602 may be connected to the inner axial bearing 604 such that the inner surface of outer axial bearing 602 faces the back plate or outer plate of inner axial bearing 604. In examples, the inner surface of outer axial bearing 602 and the back plate or outer plate of inner axial bearing 604 may be integrated into a single plate. In examples, the back plate of the outer axial bearing 602 may be an integral part of the stator. In examples, the outer axial bearing 602 may be connected, directly or indirectly, to the stator 702. In examples, the connection may be a fixed connection, i.e. for example by welding or one or more fasteners. In examples, as shown, the outer axial bearing 602 may be connected to a first stator protrusion 706, where the stator protrusion extends from or is connected to the stator 702. In examples, inner surface 610 of inner axial bearing 604 and/or of axial bearing 600 may be directed to face the rotor 704 and/or a rotor protrusion 708, where the rotor protrusion 708 extends from or is connect to rotor 704.

In examples, the bearing engagement system 700 may include a displacer 710. In examples, a displacer 710 may be configured to functionally connect a second stator protrusion 712 and/or bearing 600. In examples, a displacer 710 may be configured to functionally connect one or more second stator protrusions 712 to the stator 702. In the illustrated examples, displacer 710 is shown as functionally connecting and/or coupling at least connect a second stator protrusion 712 to stator 702. In examples, displacer 710 may be configured to linearly translate second stator protrusion 712. In examples, a displacer 710 may be configured to functionally connect bearing 600 to first stator protrusion 706. In the illustrated examples, displacer 710 is shown as functionally connecting and/or coupling at least connect bearing 600 to first stator protrusion 706. In examples, displacer 710 may be configured to linearly translate bearing 600. In examples, not shown, displacer 710 may be configured to displace both the second stator protrusion 712 and bearing 600.

In examples, the displacer 710 may include one or more motors 714. In examples, a motor 714 may be any type of suitable motor. In examples, a motor 714 may be an electric motor. In examples, one or more motors 714 may be located at the stator 702 and/or rotor 704.

FIGS. 7A and 7B illustrate an example in which the bearing engagement system 700 and/or displacer 71—are configured to displace the second stator protrusion 712 to cause contact or separation between an interface element and bearing 600. In examples, as shown in FIGS. 7A and 7B, the bearing engagement system 700 and/or displacer 710 may include a linear actuator 716. In examples, displacer 710 may include a track 718. In examples, the track 718 may include any design configured for lateral displacement and/or linear translation. In examples, the linear actuator 716 and track 718 may be configured in the same manner as previously described linear actuator 224, 228 and 232, and tracks 210, 230 and 234. In examples, the one or more tracks 718, like tracks 210, 230 and 234 have a length that is greater than a lateral thickness (or cross-sectional width) the element to be translated. In examples, the linear actuator 716 and track 718 may be configured to linearly translate a second stator protrusion 712. In examples, the linear actuator 716 may be actuated by one or more motors 714. In examples, not shown, displacer 710 may include a linear actuator configured to displace the second stator protrusion 712 and/or interface element provided thereon in a radial direction. For example, the displacer may include a telescoping arm, a sliding mechanism, a hydraulics, a piston, or any combination thereof. In such a case, the translation can be a linear translation but include a vertical or radial displacement instead of lateral displacement.

In examples, as illustrated in FIGS. 7A and 7B, as the second stator protrusion 712 is translated at least a portion of inner axial bearing 604 and/or middle plate 608 may contact an interface element 720.

In examples, as shown in FIG. 7A, the bearing engagement system 700 may include one or more interface elements 720. In examples, an interface element 720 may be the same material and design as previously described interface element 212. In examples, an interface element 720 may include a friction pad 722 just like friction pad 214 described earlier. In examples, a friction pad 722 may have at least a frictional surface configured to interface with at least a portion of axial bearing 600, middle plate 608, and/or inner axial bearing 604. In examples, an interface element 720 may include materials such as ceramics, polymers, rubber, metal, or any combination thereof. In examples, the interface element 720 may include a ceramic friction pad. In examples, an interface element 720 may include a magnetic material, an electromagnetic material, or a combination thereof. In examples, an interface element 720 may include a magnetic surface, a magnet, and/or electromagnet 724. In examples, an interface element 720 may include a combination of a friction pad and a magnetic surface, magnet and/or electromagnet. In examples, an interface element 720 may be configured to affect the rotation of the inner axial bearing 604 when pressed against a portion of inner axial bearing 604 and/or middle plate 608. In examples, an interface element 720 may be configured to couple at least a portion of inner axial bearing 604 and/or middle plate 608 to either the stator 702 or the rotor 704. In examples, by coupling at least a portion of inner axial bearing 604 and/or middle plate 608 to either the stator 702 or the rotor 704, an interface element 720 may affect the rotation of the inner axial bearing 604 and/or of middle plate 608. In examples, an interface element 720 may be configured to engage at least a peripheral portion of middle plate 608. In examples, when pressed against middle plate 608, an interface element 720 may cause the middle plate 608 to stick or affix to the interface element 720. In this manner, the rotation of the middle plate 608 and consequently, the rotation of the inner axial bearing 604 and/or outer axial bearing 602 may be controlled.

In examples, it may be possible to control the interaction between one or more interface elements 720 and the inner axial bearing 604 and/or middle plate 608. In examples, the interaction between one or more interface elements 720 and the inner axial bearing 604 and/or middle plate 608 may be controlled by switching between contacting or separating the inner axial bearing 604 and/or middle plate 608 with one or more interface elements 720. In examples, the interaction between one or more interface elements 212 and the inner axial bearing 604 and/or middle plate 608 may be controlled by laterally displacing and/or linearly translating one or more second stator protrusions 712. In examples, the lateral displacement and/or linear translation of one or more second stator protrusions 712 may be towards axial bearing 600, middle plate 608, and/or inner axial bearing 604. In examples, the lateral displacement and/or linear translation of one or more second stator protrusions 712 may be away from axial bearing 600, middle plate 608, and/or inner axial bearing 604. In examples, the lateral displacement and/or linear translation of a second stator protrusions 712 may cause middle plate 608 and/or inner axial bearing 604 to contact an interface element 720. In examples, by translating one or more second stator protrusions 712 towards and away from the axial bearing 600, inner axial bearing 604, middle plate 608, the bearing engagement system 700 may be able to control the operation of the axial bearing 600 to engage and disengage the inner axial bearing 604 and outer axial bearing 602.

FIGS. 7A and 7B illustrate an example switching operation that can be effectuated by bearing engagement system 700. FIGS. 7A and 7B illustrate an example in which a rotor 704 may exert a thrust force in along its long axis in the direction “T” while it is rotating about its long axis. In examples, as shown, rotor 704 may include a rotor protrusion 708. In examples, in this manner, rotor protrusion 708 may exert a thrust force onto first stator protrusion 706. In examples, as illustrated in FIGS. 7A and 7B, an axial bearing 600 may be provided between the first stator protrusion 706 and the rotor protrusion 708 at the interface at which the first stator protrusion 706 and the rotor protrusion 708 would otherwise make contact.

In examples, as shown in FIG. 7A, the second stator protrusion 712 is at a distance from axial bearing 600. In examples, the second stator protrusion 712 with interface element 720 thereon, is sufficiently far from axial bearing 600 to not have any contact or interaction between interface element 720 and axial bearing 600. In this state, as the rotating rotor 704 causes rotating rotor protrusion 708 to exert a thrust force and thus press against the inner surface 610 of axial bearing 600. The rotational motion of the rotating rotor protrusion 708 may cause rotation of at least a portion of axial bearing 600. Without any interaction between interface element 720 and axial bearing 600, the outer axial bearing 602 of axial bearing 600 will be engaged. In examples, as outer axial bearing 602 is engaged the inner axial bearing 604 may rotates with the rotating rotor protrusion 708.

In examples, it may be desirable to switch between engagement of the outer axial bearing 602 and the inner axial bearing 604. For example, at the start when the rotor 704 is rotating at a lower speed, the outer axial bearing 602 may include a ball or roller bearing that can support the rotation while the rotational speed is below a threshold to form an air or gas film at the gas bearing. As the speed of the rotor 704 increases, however, it may be desirable to switch to inner axial bearing 604 that may include an axial bearing that can allow higher rotational speed than a non-lubricated ball or roller bearing and/or that may operate with less friction, such as for example, an axial leaf-type bearing.

In examples, based at least on the status of axial bearing 600 or portion thereof, and/or of the rotor 704 it may be possible to control the interaction between the inner axial bearing 604 and/or middle plate 608 and one or more interface elements 720. In examples, the status of the rotor 704 and/or of the axial bearing 600 or portion thereof, such as for example the status of a axial leaf-type bearing if included in the axial bearing 600, may include, but not be limited to, the rotational speed of the rotor 704, the rotational speed of the rotor 704 relative the inner axial bearing 604, the rotational speed of the inner axial bearing 604, the rotational speed of the outer axial bearing 602, the rotational speed of the axial leaf-type bearing if present (whether it be the inner axial bearing 604 or the outer axial bearing 602), the rotational speed of the non-leaf-type foil bearing (whether it be the inner axial bearing 604 or the outer axial bearing 602), the presence of an air or other gas film adjacent a surface, such as for example the surface of the leaves or petals of the axial leaf-type bearing, or any combination thereof. It should be recognized that when the inner axial bearing 604 is allowed to rotate with the rotor 704, the rotational speed of the inner axial bearing 604 may be the same as the rotational speed of the rotor 704. In such cases, detection of rotational speed of the rotor 704 may also provide the rotational speed of the inner axial bearing 604 and vice versa. In examples, one or more sensors (not shown) may be used to detect one or more of these status indicators for the axial leaf-type bearing and/or of the rotor. For example, it may be possible using one or more sensors to detect if the rotation of rotor 704, inner axial bearing 604, outer axial bearing 602, or of a axial leaf-type bearing, exceeds or reaches a point above a predetermined threshold rotational speed.

In examples, based at least on the status of the axial leaf-type bearing and/or of the rotor, it may be possible to control the interaction between the inner axial bearing 604 and/or middle plate 608 and one or more interface elements 720. In examples, at a given status of the axial leaf-type bearing and/or rotor, for example, at a given rotational speed of the axial leaf-type bearing and/or rotor, to reduce friction exerted onto the surface of the rotor protrusion 708 the bearing engagement system 700 may effectuate a switch in the operation of axial bearing 600 from the roller and/or ball bearing used for outer axial bearing 602 to the axial leaf-type bearing used as inner axial bearing 604 to promote the formation of a film of air or other gas between inner surface 610 and the surface of the rotor protrusion 708. In examples, one or more suitable controllers 726 that may include one or more microprocessors, memory, hardware and/or software instructions, may be used to enable the control using one or more signals based on the sensed status. In examples, the switch may be triggered based on sensor information and/or a set of stored and/or manually entered instructions. In examples, the one or more controllers 726 may control motor 714. In examples, motor 714 may be operated to linearly translate one or more second stator protrusions 712 towards the axial bearing 600, inner axial bearing 604, middle plate 608, as, for example, shown in FIG. 7B. In examples, the lateral displacement and/or linear translation may be guided by track 718. In examples, as a second stator protrusions 712 is translated towards the axial bearing 600, inner axial bearing 604, middle plate 608, or any combination thereof, interface element 720 provided on second stator protrusion 712 is moved towards and is eventually pressed against inner axial bearing 604 and/or middle plate 608. In examples, the friction exerted by friction pad 722 of interface element 720 and/or magnetic field by electromagnet 724 that the inner axial bearing 604 and/or middle plate 608 experiences may cause the inner axial bearing 604 and/or middle plate 608 to assume a fixed location relative to interface element 720. In examples, during this state, the stationary or fixed position of the stator 702 maintains the interface element 720 that is attached to the second stator protrusion 712 in a stationary or fixed position. As such, as the interface element 720 is stationary or in a fixed position, the middle plate 608 and inner axial bearing 604 are also in a stationary or fixed position relative to the stator 702. In this state, the inner axial bearing 604, middle plate 608, and/or inner surface 610 may be maintained substantially still. In this state, the outer axial bearing 602 is disengaged and not operating. In this state, the inner axial bearing 604 is engaged. In examples, the inner axial bearing 604 allows for the free rotation of the rotor 704 by way of the air or other gas film created between rotor protrusion 708 and the inner surface 610 of axial bearing 600. In examples, this can allow for a lowered or no friction rotation of rotor 704.

In examples, as shown in FIG. 7B illustrates a displacer 710, via a motor 714, translates a second stator protrusion 712 with interface element 720 towards the axial bearing 600, inner axial bearing 604, middle plate 608. In examples, interface element 720 may be provided on a surface of the second stator protrusion 712. As this translation occurs, the interface element 720 and inner axial bearing 604 and/or middle plate 608 come in contact. In examples, the friction provided by the friction pad 722 and/or by magnetic field provided by electromagnet 724 that bearing 604 and/or middle plate 608 experiences may cause the middle plate 608 to assume a fixed location relative to the first interface element 720.

In examples, the operation of axial bearing 600 may be controlled by bearing engagement system 700 by translating one or more second stator protrusions 712 towards or away from axial bearing 600 as may be desired. In the above examples, the switching can be used to take advantage of a roller and/or ball bearing during lower rotational speed of the rotor and/or and of a leaf-type bearing for greater rotational speed and low to no friction rotation at higher rotational speeds of the rotor when lift off speed is reached for a given load. This is only an example. In additional examples, switching may be performed for backup bearing functionality, for other types of bearing combinations, or any other desirable need.

In examples, as shown in FIG. 7C, the bearing engagement system 700 and/or displacer 710 may be configured to displace bearing 600. In examples, the bearing engagement system 700 and/or displacer 710 may be configured to displace bearing 600 alone or in combination with second stator protrusion 712. In examples, the bearing engagement system 700 and/or displacer 710 may include a linear actuator 736. In examples, the displacer 710 may include a track 738. In examples, linear actuator 736 and track 738 may be designed and implemented in the same manner as linear actuator 716 and track 718 previously described. In examples, linear actuator 736 and track 738 may be provided on the first stator protrusion 706. In this manner, the displacer may be configured to functionally connect and/or couple bearing 600 to stator 702 and/or first stator protrusion 706. As arranged, the linear actuator 736 and track 738 may cause linearly translation of bearing 600 in the radial or vertical direction, i.e. towards and away stator 702. In examples, the second stator protrusion 712 and/or interface element 720 may be located at a fixed location on stator 702 and/or functionally connected and/or coupled to the stator 702 as previously described. In the illustrated example of FIG. 7C, second stator protrusion 712 and/or interface element 720 are shown at a fixed location on stator 702. In examples, second stator protrusion 712 may not be necessary and omitted and interface element 720 may be provided directly on stator 702. In examples, interface element 720 and optionally second stator protrusion 712 may be arranged on stator 702 above bearing 600. In examples, as the displacer 710 linearly translates bearing 600 towards stator 702 and/or interface element 720, it may cause interface element 720 to contact inner bearing 604 and/or middle plate 608. In examples, as displacer 710 linearly translates bearing 600 away from stator 702 and/or interface element 720, it may cause separation or distancing of interface element 720 to from inner bearing 604 and/or middle plate 608. By controlling the interaction between the interface element 720 and inner bearing 604 and/or middle plate 608 by displacing bearing 600, displacer 710 can control engagement and disengagement of inner bearing 604 in a similar manner as previously described with reference to FIGS. 7A and 7B.

In examples, the bearing engagement system 700 may include one or more electromagnets 728 to form a magnetic field configured to apply a magnetic torque to the inner axial bearing 604 as similarly described earlier with reference to FIG. 3A. In examples, bearing engagement system 700 may control the operation of axial bearing 600 as described above by the application of such torque. In examples, bearing engagement system 700 may include one or more electromagnets 728. In examples, an electromagnet 728 may include a coil or winding of electrically conducting material. In examples, electromagnet 728 may include an electromagnetic coil or winding. In examples, one or more electromagnets 728 may be provided in the stator 702, rotor 704, or both. In examples, one or more magnets or poles 730 may be provided in and/or built into the axial bearing 600, inner axial bearing 604, middle plate 608, and/or inner surface 610. In examples, as illustrated in FIG. 7D, one or more electromagnets 728 may be provided on the stator 702 and one or more magnets or poles 730 may be provided in middle plate 608.

In examples, bearing engagement system 700, via one or more electromagnets 728, may generate a magnetic field around at least a portion of axial bearing 600. In examples, the magnetic field may extend to at least a portion of the axial bearing system where the middle plate 608 or inner surface 610 are located. In examples, bearing engagement system 700 via the one or more electromagnets 728 may be configured to be able to control the magnetic field. In examples, control of a magnetic field may include turning it on and off, modifying magnitude, modifying direction, or any combination thereof. In so doing, it may be possible to apply and/or induce a torque to axial bearing 600, inner axial bearing 604, middle plate 608, and/or inner surface 610. In examples, the torque may be generated by the magnetic field opposing eddy currents that may be created by the rotating axial bearing 600, inner axial bearing 604, middle plate 608, and/or inner surface 610. By applying the torque via a magnetic field, the bearing engagement system 700 may thus control and/or affect the rotation of axial bearing 600, inner axial bearing 604, middle plate 608, and/or inner surface 610. In examples, where the magnets or poles 730 are provided in middle plate 608, the application of the torque via magnetic field would affect the rotation of middle plate 608. In examples, rotation of the middle plate 608 may affect rotation of inner axial bearing 604 and/or inner surface 610. In examples, the application of the torque via a magnetic field can lead to slowing and/or stopping the rotation of inner axial bearing 604, middle plate 608, and/or inner surface 610. In this manner, the bearing engagement system 700 may switch between the engagement of the outer axial bearing 602 and inner axial bearing 604.

In examples, control of the electromagnetic field via electromagnets 728 and thus application of the torque may be used to allow for rotation of inner axial bearing 604, middle plate 608, and/or inner surface 610, induce rotation of inner axial bearing 604, middle plate 608, and/or inner surface 610, and/or impede rotation of inner axial bearing 604, middle plate 608, and/or inner surface 610. In examples, inducing rotation of inner axial bearing 604, middle plate 608, and/or inner surface 610 may include inducing rotation in the same direction as the rotor 704 or in the opposite direction of the rotor 704. In examples, inducing rotation in the opposite direction of rotor 704 may achieve an artificially high relative rotational speed of the axial leaf-type bearing and/or of inner axial bearing 604, middle plate 608, and/or inner surface 610 with respect to the rotor 704 to assist achieving lift off speed and creating an air or other gas film between the inner surface 610 and the rotor protrusion 708. In examples, once the rotational speed of the rotor protrusion 708 relative the inner axial bearing 604, middle plate 608, and/or inner surface 610 reaches or surpasses a threshold, the inner axial bearing 604, middle plate 608, and/or inner surface 610 may be caused to come to a stop by control of the magnetic field allowing for an air or other gas film between the rotor protrusion 708 and inner surface 610 to be formed and thus letting the rotor to continue to freely rotate while continuing to exhibit a thrust force onto first stator protrusion 706.

For example, as previously described, a dual bearing may include an outer axial bearing 602 such as a roller and/or ball bearing and an inner axial bearing 604 such as a axial leaf-type bearing. In examples, as the rotor commences to rotate, the engagement system may control one or more electromagnets 728, for example in the off state, thereby not forming a magnetic field. In this state, the inner surface 610 may be in contact with the surface of the rotor protrusion 708. In this state, the inner axial bearing 604 may rotate with the rotor protrusion 708. In this state, in examples, the outer axial bearing 602 may be engaged and accommodate the rotation of the rotor protrusion 708 via the roller and/or ball bearing of outer axial bearing 602. In examples, status of axial bearing 600 or of a portion thereof, for example, of a axial leaf-type bearing if one is present, and/or of rotational speed of rotor 704, the one or more electromagnets 728 may be engaged to switch between the outer axial bearing 602 and the inner axial bearing 604. In examples, the status of axial bearing 600 or of a portion thereof and/or the rotational speed of rotor 704 or rotor protrusion 708 may be detected as previously described. For example, as the rotation of rotor 704 or rotor protrusion 708 and/or of inner axial bearing 604, or the rotational speed of the rotor 704 or rotor protrusion 708 relative the inner axial bearing 604, reaches or goes above a threshold, the axial leaf-type bearing may be engaged to allow for a film of air or other gas to form between the surface of rotor protrusion 708 and the inner surface 610 of axial bearing 600 to lower the friction axial bearing 600 imposes on the rotor protrusion 708. In examples, to engage the axial leaf-type bearing the bearing engagement system 700 may switch from engaging the outer axial bearing 602 to engaging the inner axial bearing 604. As indicated earlier, one or more controllers 726 may be used to effectuate the switch based on sensor information and/or a set of stored and/or manually entered instructions.

In examples, the one or more controllers 726 may control and/or activate and deactivate the one or more electromagnets 728. In examples, the bearing engagement system 700 may power the one or more electromagnets 728 to control and/or generate a magnetic field. In so doing, the magnetic field can affect the one or more magnets or poles 730 and thus result in a torque being applied to axial bearing 600, middle plate 608, inner axial bearing 604, inner surface 610, or any combination thereof. In applying such a torque, the rotation of inner axial bearing 604, middle plate 608, and/or inner surface 610 may be slowed and/or stopped. In this state, the inner axial bearing 604, middle plate 608, and/or inner surface 610 may be maintained substantially still. For purposes of this disclosure, substantially still means no functionally relevant movement from a fixed position. As inner axial bearing 604 comes to a stop, it can be engaged due to the axial leaf-type bearing design and allow for a film of air or other gas to form between inner axial bearing 604 and rotor protrusion 708, thus allowing the rotor to freely rotate while exerting a thrust force onto the first stator protrusion 706. In examples, as the inner axial bearing 604 and/or middle plate 608 are maintained substantially still and/or in a static state the operation of the outer axial bearing 602 will be disengaged as it no longer accommodates for the rotation. In examples, when the engagement of the outer axial bearing 602 is again desired, the electromagnets can be turned off, thereby eliminating the magnetic field and allowing the middle plate 608 and/or inner axial bearing 604 to again rotate with the rotor.

The above example referencing FIG. 7D describes a system in which an axial bearing 600 may include a hybrid dual bearing with an inner axial bearing 604 including a axial leaf-type bearing and an outer axial bearing 602 including a roller and/or ball bearing. As previously discussed, this is just an example. In examples, the axial bearing 600 may include a dual bearing with the same or different types of axial bearing for inner and outer bearings. In examples, the bearing 600 may include a ball or roller bearing as the inner bearing 604. In examples, the application of the magnetic field may be used to switch between engagement of the outer axial bearing 602 and the inner axial bearing 604 for any desired reason. For example, it may be used to switch to a bearing to be used as a backup.

FIG. 7E illustrates an example in which an axial bearing system 700 as described in FIGS. 7A-7B but with an inverted bearing 600. In examples, as shown in FIG. 7E, bearing 600 is arranged such that the inner axial bearing 604 may include a ball or roller bearing and outer axial bearing 602 may include a gas bearing exemplified as a axial leaf-type bearing. As illustrated in FIG. 7D, the inner axial bearing 604 may be fixed to rotor protrusion 708. In examples, inner axial bearing 604 may be affixed to rotor protrusion 708 in the same manner as the outer axial bearing 602 was previously described with respect to first stator protrusion 706. In examples, as shown, outer axial bearing 602 may be fixed to first stator protrusion 706 in a similar manner as previously described. In examples, the axial bearing 600 may be arranged such that the leaf petals of the axial leaf-type bearing on an inner surface of the outer axial bearing 602 face the outer surface or backplate of the inner axial bearing 604. In this manner as the rotor protrusion 708 exerts a thrust force against the first stator protrusion 706, the outer surface or backplate of inner bearing 604 is pressed against the inner surface or leaf petals of the outer axial bearing 602.

In examples, rotor 704 may include a second rotor protrusion 732. In examples, a displacer 710 may be configured as previously described with a linear actuator and a track but configured to linearly translate a second rotor protrusion 732 instead of a second stator protrusion 708. In examples, not shown, displacer 710 may include a linear actuator configured to displace the second rotor protrusion 732 and/or interface element provided thereon in a radial direction. For example, the displacer may include a telescoping arm, a sliding mechanism, a hydraulics, a piston, or any combination thereof. In such a case, the translation can be a linear translation but include a vertical or radial displacement instead of lateral displacement. In examples, second rotor protrusion 732 may include an interface element 734 similar to interface element 720 previously described. In examples, interface element 734 and second rotor protrusion 732 may be arranged such that as the second rotor protrusion 732 translates towards middle plate 608 and/or outer axial bearing 602 it can cause translation of interface element 734 towards middle plate 608 and/or back plate of inner axial bearing 604. In examples, upon sufficient translation the interface element 734 may contact the middle plate 608 and/or back plate of inner axial bearing 604 thus coupling it with the rotation of the rotor 704 and effectively disengaging inner axial bearing 604. This in turn can cause engagement of the outer axial bearing 602 by forming a film of air or other gas between the back plate of middle plate 608 and/or inner axial bearing 604 and the leaf petals on the inner surface of the outer axial bearing 602. In examples, by translating the second rotor protrusion 732 away from middle plate 608 and/or outer axial bearing 602, the interface element 734 may be translated away and/or separated from middle plate 608 and/or outer axial bearing 602 thus allowing for engagement and operation of the inner axial bearing 604 and disengagement of outer axial bearing 602.

As shown in FIG. 7F, the example illustrated in FIG. 7E may also be implemented as previously described with reference to FIG. 7C by linearly translating bearing 600. In examples, a linear actuator 736 and track 738 may be provided the first stator protrusion 706 as previously described. In examples, a linear actuator 740 and track 742 may be provided on the first rotor protrusion 708. In examples, the two linear actuators 736 and 740 and tracks 738 and 742 may be configured to translate the inner axial bearing 604 and outer axial bearing 602 towards or away from rotor 704. In examples, the translation of inner axial bearing 604 by linear actuator 740 on track 742 and the translation of outer axial bearing 602 by linear actuator 736 and track 738 may be carried out at the same time or simultaneously. In examples, the interface element 734 and optionally second rotor protrusion 732 may be provided at a fixed position on rotor 704 below bearing 600 such that as bearing 600 is translated towards rotor 704, contact may be caused between interface element 734 and inner axial bearing 604 and/or at least a portion of middle plate 608. In this manner, the interaction between interface element 734 and inner axial bearing 604 and/or at least a portion of middle plate 608 may be controlled by translating bearing 600 towards and away from rotor 704. In this manner, bearing engagement system 700 may control the engagement and disengagement of inner axial bearing 604 in the same manner as described with reference to FIG. 7E. In examples, the bearing engagement system 700 and/or displacer 710 may be configured to translate both bearing 600 and second rotor protrusion 732 to control the interaction between interface element 734 and bearing 600.

In examples, the use of one or more electromagnets 728 as described with reference to FIG. 7D may be combined with the translation of one or more second stator protrusions 712 as previously described with reference to FIGS. 7A and 7B, bearing 600 as described above in FIGS. 7C and 7F, and/or with one or more second rotor protrusion 732 as described with reference to FIG. 7E.

In examples, although not shown, the same vibration dampener systems described with reference to FIGS. 5A-5D may be also implemented in a similar manner in the bearing systems as described with reference to FIGS. 7A-7E.

In examples, although not shown, the systems described herein may include one or more sensors as generally employed in the art. In examples, sensors may be used to monitor the operation of the systems described. Non-limiting examples of one or more sensors may include speed sensors, rotational sensors, pressure sensors, flow meters, and other like sensors.

In examples, although not shown, the one or more controllers may include any suitable computing devices that may be employed to control one or more of portions of systems described herein. Controllers may include one or more processors and memory communicatively coupled with each other. In the illustrated example, a memory may be used to store logic instructions to operate and/or control and/or monitor the operation of the bearing system described and/or of any subcomponent thereof, the spent catalyst source, or both. In examples, the controllers may include or be coupled to input/output devices such as monitors, keyboards, speakers, microphones, computer mouse and the like. In examples, the one or more controllers may also include one or more communication components such as transceivers or like structure to enable wired and/or wireless communication. In examples, this may allow for remote operation of one or more systems described herein.

In examples, memory associated with the one or more controllers and/or other suitable computing devices may be non-transitory computer-readable media. The memory may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The controls systems may include any number of logical, programmatic, and physical components.

Logic instructions may include one or more software modules and/or other sufficient information for autonomous operation, safety procedures, and routine maintenance processes. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

In examples, bearing engagement system may include one or more controllers 226, 306, 426 and/or 726 and sensors (not shown) configured to ensure that when an interface element contacts inner bearing 104 or 604 and/or middle ring 108 or middle plate 608, the outer ring of inner bearing 104 or 604 and/or middle ring 108 or middle plate 608 stop at a desired angular position. In examples, one or more sensors may include visual sensors configured to detect a marking on the outer ring of inner bearing 104 or 604 and/or middle ring 108 or middle plate 608. The marking may be a graphic, such as a line, a surface contour, such as bump or other protrusion, or any other detectable feature, and any combination thereof. In examples, one or more additional sensors may be provided to detect the rotational speed of the rotor and/or of the outer ring or back plate of inner bearing 104 or 604 and/or middle ring 108 or middle plate 608. In examples, one or more additional sensors may be provided to measure the pressure at which an interface element in pressed against inner bearing 104 or 604 and/or middle ring 108 or middle plate 608, and/or the translation speed of the bearing 100 or 600, one or more interface elements, or both. In examples, one or more additional sensors may be provided to measure the strength of the magnetic torque applied to inner bearing 104 or 604 and/or middle ring 108 or middle plate 608. In examples, the one or more controllers 226, 306, 426, and/or 726 may be programmed to receive information from the one or more different sensors and determine the degree of rotation by the outer ring of inner bearing 104 or 604 and/or middle ring 108 or middle plate 608 before it comes to a stop. In examples, the one or more controllers may be programmed to control the bearing engagement system so that the appropriate pressure imposed by the one or more interface elements and/or magnetic torque applied by one or more electromagnet onto inner bearing 104 or 604 and/or middle ring 108 or middle plate 608, will cause the outer ring or back plate of inner bearing 104 or 604 and/or middle ring 108 or middle plate 608 to come to a stop at a desired angular position and/or within a desired range of angular positions.

In examples, as described above provided is a bearing system including bearing and a bearing engagement system, wherein the bearing can be a dual bearing and can be a radial bearing or an axial bearing, and wherein the bearing engagement system may be configured to control the engagement of an inner bearing and/or of an outer bearing.

In examples, provided is a radial bearing system that may include an outer bearing; an inner bearing concentric with the outer bearing and encircled by the outer bearing; a radial bearing engagement system configured to control a rotation of the inner bearing, the radial bearing engagement system that may include: a displacer configured to linearly translate at least the inner bearing, displace an interface element, or both; or an electromagnet configured to generate a magnetic field to apply a magnetic torque to the inner bearing.

In examples, the outer bearing may include a ball bearing, a roller bearing, or a combination of both. In examples, the outer bearing may include a lubricant. In examples, the inner bearing may include a gas bearing such as a foil bearing such as an air foil bearing. In examples, the inner bearing may include a gas bearing such as a foil bearing such as an air foil bearing and the outer bearing may include a ball bearing, a roller bearing, a lubricant, or any combination thereof.

In examples, the radial bearing engagement system may include the displacer and the electromagnet configured to generate a magnetic field to apply a magnetic torque to the inner bearing. In examples, the radial bearing engagement system may include the displacer. In examples, the radial bearing engagement system may include a linear actuator and a track having a length that is greater than a lateral thickness of the outer bearing. In examples, the radial bearing engagement system may include a motor.

In examples, the radial bearing engagement system may include a first interface element. In examples, the first interface element may include a ceramic, a polymer, a metal, a rubber, an electromagnetic or magnetic material, or a combination thereof. In examples, the first interface element may include a first friction pad, a magnet, an electromagnet, or a combination thereof. In examples, the first interface element may be configured to couple at least a portion of the inner bearing to a rotor. In examples, the first interface element may be located on a portion of the rotor.

In examples, the radial bearing engagement system may include a second interface element. In examples, the second interface element may include a ceramic, a polymer, a metal, a rubber, an electromagnetic material, a magnetic material, or a combination thereof. In examples, the second interface element may include a second friction pad, a magnet, an electromagnet, or a combination thereof. In examples, the second interface element may be configured to couple at least a portion of the inner bearing to a stator. In examples, the second interface element may be located on a portion of the stator.

In examples, the displacer may include a mechanical arm, a telescoping arm, a hydraulics, a piston, or a combination thereof to displace the interface element.

In examples, the radial bearing engagement system may include the electromagnet configured to generate a magnetic field to induce a magnetic torque to the inner bearing. In examples, the electromagnet may be located at the stator.

In examples, provided is a method of controlling a rotation of an inner bearing relative to an outer bearing that is concentric with and surrounds the inner bearing that may include: controlling an interaction between the inner bearing and at least one interface element by: laterally translating the inner bearing, displacing an interface element, or both; applying a magnetic torque to the inner bearing; or both.

In examples, the method may include controlling the interaction between the inner bearing and the interface element by laterally translating the inner bearing, displacing an interface element, or both. In examples, the at least one interface element may include a first interface element and a second interface element, and controlling the interaction between the inner bearing and the at least one interface element further may include switching between contacting the inner bearing with the first interface element and contacting the inner bearing with the second interface element. In examples, the laterally translating may include linearly displacing the inner bearing towards a surface of a stator or towards a surface of a rotor. In examples, a first interface element may be provided on a portion of the rotor and a second interface element may be provided on the stator, and the method may include causing the inner bearing to rotate with the rotor when contacting the inner bearing with the first interface element; and causing the inner bearing to remain substantially still relative to the stator when contacting the inner bearing with the second interface element. In examples, laterally displacing the inner bearing may include engaging a linear actuator.

In examples, the method may include applying the magnetic torque to the inner bearing using a magnetic field. In examples, the method may include controlling one or more electromagnets to control the magnetic field. In examples, applying the magnetic torque to the inner bearing may include impeding the rotation of the inner bearing. In examples, impeding the rotation of the inner bearing may include maintaining the inner bearing substantially still.

In examples, the inner bearing may include an air foil bearing, and the method may include controlling the interaction between the inner bearing and at least one interface element or applying magnetic torque to the inner bearing using an electromagnetic field based at least in part on a status of the air foil bearing, of a rotor, or both. In examples, controlling the interaction between the inner bearing and at least one interface element may be based at least in part on a status of the air foil bearing, wherein the status of the air foil bearing comprises a rotational speed of the air foil bearing, a rotational speed of the outer bearing, presence of an air film adjacent to a surface of the air foil bearing, or any combination thereof. In examples, the method may include causing the air foil bearing to rotate when in a first state, and to remain substantially still when in a second state. In examples, the outer bearing may include a roller bearing or a ball bearing, and the method may include engaging the outer bearing when the air foil bearing rotates. In examples, the method may include causing the air foil bearing to rotate with the rotor when the rotor is below a threshold rotational speed, and causing the air foil bearing to become substantially still to induce formation of an air film to form between the air foil bearing and a rotor once the rotor reaches a threshold rotational speed. In examples, the method may include causing the air foil bearing to rotate in an opposite direction relative to the rotor when the rotor is below a threshold rotational speed, and causing the air foil bearing to become substantially still to induce formation of an air film to form between the air foil bearing and a rotor once the relative rotational speed between the rotor and the air foil bearing reaches a threshold value.

In examples, the method may include controlling the interaction between the inner bearing and the interface element by laterally displacing the inner bearing and applying the magnetic torque to the inner bearing using an electromagnetic field.

In examples, provided is a system that may include a rotor; a stator; a bearing that may include an inner bearing surrounding the rotor; and an outer bearing concentric with the inner bearing, the outer bearing surrounding the inner bearing and functionally connected to the stator; and

a radial bearing engagement system configured to control a rotation of the inner bearing, the radial bearing engagement system may include: a displacer configured to linearly translate at least the inner bearing, displace an interface element, or both; or an electromagnet configured to generate a magnetic field to apply a magnetic torque to the inner bearing.

In examples, the rotor may include a first interface element and the stator further comprising a second interface element. In examples, the displacer may include a linear actuator configured to displace the inner bearing between the first interface element and the second interface element.

In examples, when in contact with the inner bearing the first interface element may be configured to cause the inner bearing to rotate with the rotor; and the second interface element may be configured to maintain the inner bearing still with the stator.

In examples, the displacer may include a mechanical arm, a telescoping arm, a hydraulics, a piston, or a combination thereof to displace the interface element.

In examples, the displacer may cause a stator protrusion to laterally displace towards the bearing. In examples, the stator protrusion may include a thrust bearing. In examples, the as the stator protrusion is laterally displaced, the thrust bearing is caused to press against a sliding element coupled to a rotor protrusion. In examples, as the sliding element is configured to slide toward the bearing as the thrust bearing presses against it. In examples, the sliding element may include an interface element. In examples, as the sliding element slides toward the bearing it may cause the interface element to contact the inner bearing. In examples, the sliding element may be configured to spring back into its original position when the thrust bearing does not press against it. In examples, it its original position, the interface element on the sliding element is separated from or distanced from or does not contact the bearing.

In examples, the radial bearing engagement system may include the electromagnet, wherein the electromagnet may include one or more electromagnets. In examples, the radial bearing engagement system may include a controller configured to control operation of the one or more electromagnets. In examples, the bearing may include one or more magnets or poles. In examples, the inner bearing may include an air foil bearing. In examples, the outer bearing may include a roller bearing, a ball bearing, a lubricated bearing, or any combination thereof. In examples, the radial bearing system may be configured such that the outer bearing is engaged when the inner bearing rotates.

In examples, provided is a method of operating a hybrid bearing that may include an inner bearing concentric with an outer bearing, the method may include coupling the inner bearing to a rotor; coupling the outer bearing to a stator; and controlling a rotation of the inner bearing relative to the outer bearing by: controlling an interaction between the inner bearing and a first interface element located on the rotor and a second interface element located on the stator by laterally displacing the inner bearing, displacing an interface element, or both; or applying magnetic torque to the inner bearing using a magnetic field; or both.

In examples, the method may include controlling the interaction between the inner bearing and the first interface element located on the rotor and the second interface element located on the stator by laterally displacing the inner bearing, displacing an interface element, or both and by applying magnetic torque to the inner bearing using a magnetic field. In examples, controlling a rotation of the inner bearing relative to the outer bearing may include controlling an interaction between the inner bearing and the first interface element and the second interface element by contacting the inner bearing with the first interface element or the second interface element.

In examples, the laterally displacing may include linearly translating the inner bearing between the first interface element and the second interface element. In examples, controlling the interaction between the inner bearing and the first interface element may include causing the inner bearing to rotate with the rotor. In examples, controlling the interaction between the inner bearing and the first interface element may include causing the inner bearing to rotate in direction counter to that of the rotor. In examples, controlling the interaction between the inner bearing and the second interface element may include causing the inner bearing to remain still relative to the stator.

In examples, controlling the interaction between the inner bearing and the first interface element and the second interface element may include switching between contacting the inner bearing with the first interface element to contacting the inner bearing with the second interface element or vice versa. In examples, controlling the interaction between the inner bearing and the first interface element and the second interface element may include detecting a rotational speed of the rotor above a threshold, a rotational speed of the rotor relative the inner bearing above a threshold, a rotational speed of the inner bearing above a threshold, or a combination thereof; and switching, based on the detecting, the inner bearing from contacting the first interface element to contacting the inner bearing with the second interface element.

In examples, the stator may include one or more electromagnets, wherein controlling a rotation of the inner bearing relative to the outer bearing comprises applying magnetic torque to the inner bearing using a magnetic field by activating the one or more electromagnets. In examples, applying magnetic torque to the inner bearing may include detecting a rotational speed of the rotor above a threshold, a rotational speed of the rotor relative the inner bearing above a threshold, a rotational speed of the inner bearing above a threshold, or a combination thereof; and activating, based on the detecting, the one or more electromagnets to generate a magnetic field configured to impede rotation of the inner bearing.

In examples, provided is an axial bearing system that may include an outer bearing; an inner bearing side-by-side with the outer bearing; an axial bearing engagement system configured to control a rotation of the inner bearing, the axial bearing engagement system that may include: a displacer configured to linearly translate at least the inner bearing, displace an interface element, or both; or an electromagnet configured to generate a magnetic field to apply a magnetic torque to the inner bearing.

In examples, the displacer is configured to linearly translate the interface element in a lateral direction or in a radial direction.

In examples, the displacer is configured to linearly translate the bearing.

In examples, the interface element is located on a stator.

In examples, the interface element is located on a rotor.

In examples, the outer bearing may include a ball bearing, a roller bearing, or a combination of both. In examples, the outer bearing may include a lubricant. In examples, the inner bearing may include a gas bearing. In examples, the gas bearing may include a leaf-type bearing or thrust bearing. In examples, the gas bearing may include a foil bearing. In examples, the inner bearing may include a gas bearing and the outer bearing may include a ball bearing, a roller bearing, a lubricant, or any combination thereof.

In examples, the inner bearing may include a ball bearing, a roller bearing, or a combination of both. In examples, the inner bearing may include a lubricant. In examples, the outer bearing may include a gas bearing. In examples, the gas bearing may include a leaf-type bearing or thrust bearing. In examples, the gas bearing may include a foil bearing. In examples, the outer bearing may include a gas bearing and the inner bearing may include a ball bearing, a roller bearing, a lubricant, or any combination thereof.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A bearing system comprising:
a dual bearing comprising:
an inner bearing; and
an outer bearing; and
a bearing engagement system configured to control a rotation of the inner bearing, the bearing engagement system comprising:
a displacer configured to linearly translate at least the inner bearing, displace an interface element, or both; or
an electromagnet configured to generate a magnetic field to apply a magnetic torque to the inner bearing.

2. The bearing system of claim 1, wherein the dual bearing comprises a hybrid dual bearing wherein the inner bearing is different from the outer bearing.

3. The bearing system of claim 1, wherein the dual bearing is free of lubricant.

4. The bearing system of claim 1, wherein the dual bearing comprises a dual radial wherein the outer bearing is concentric with and surrounds the inner bearing or a dual axial bearing wherein the outer bearing and the inner bearing are adjacent and side-by-side to each other.

5. The bearing system of claim 1, wherein the inner bearing comprises a gas bearing, and the outer bearing comprises a ball bearing, a roller bearing, a lubricant, or any combination thereof.

6. The bearing system of claim 1, wherein the outer bearing comprises a gas bearing, and the inner bearing comprises a ball bearing, a roller bearing, a lubricant, or any combination thereof.

7. The bearing system of claim 1, wherein the bearing engagement system comprises the displacer and the electromagnet configured to generate a magnetic field to apply a magnetic torque to the inner bearing.

8. The bearing system of claim 1, wherein the bearing engagement system comprises the displacer comprising one or more linear actuators and one or more tracks.

9. The bearing system of claim 9, the bearing engagement system further comprising one or more interface elements.

10. The bearing system of claim 9, wherein at least one interface element of the one or more interface elements is:
located on a portion of a rotor and configured to couple at least a portion of the inner bearing to the rotor; or
located on a portion of a stator and configured to couple at least a portion of the inner bearing to the stator.

11. The bearing system of claim 9, wherein at least a first interface element of the one or more interface elements is located on a portion of a stator and configured to couple at least a portion of the inner bearing to the stator, and at least a second interface element of the one or more interface elements is located on a portion of a rotor and configured to couple at least a portion of the inner bearing to the rotor.

12. The bearing system of claim 1, wherein the bearing engagement system comprises the electromagnet configured to generate a magnetic field to induce a magnetic torque to the inner bearing, wherein the electromagnet is located on a stator or on a rotor.

13. The bearing system of claim 1, further comprising a vibration dampener.

14. The bearing system of claim 1, further comprising a controller configured to control the displacer, the electromagnet, or both.

15. The bearing system of claim 14, wherein the controller is configured to stop the rotation of the inner bearing at a predetermined angular position.

16. A method of controlling a rotation of an inner bearing relative to an outer bearing in a dual bearing comprising:
controlling an interaction between the inner bearing and at least one interface element by:
laterally displacing the inner bearing, an interface element, or both;
applying a magnetic torque to the inner bearing; or
both.

17. The method of claim 16, comprising controlling the interaction between the inner bearing and the interface element by laterally displacing the inner bearing, an interface element, or both.

18. The method of claim 17, wherein the at least one interface element comprises a first interface element and a second interface element, and wherein controlling the interaction between the inner bearing and the at least one interface element further comprises switching between contacting the inner bearing with the first interface element and contacting the inner bearing with the second interface element.

19. The method of claim 18, wherein a first interface element is provided on a portion of a rotor and a second interface element is provided on a stator, further comprising:
causing the inner bearing to rotate with the rotor when contacting the inner bearing with the first interface element; and
causing the inner bearing to remain substantially still relative to the stator when contacting the inner bearing with the second interface element.

20. The method of claim 16, comprising applying the magnetic torque to the inner bearing using a magnetic field by controlling one or more electromagnets to control the magnetic field.

21. The method of claim 20, wherein applying the magnetic torque to the inner bearing comprises impeding the rotation of the inner bearing to maintain the inner bearing substantially still.

22. The method of claim 16, wherein the inner bearing comprises a gas bearing and further comprising:
controlling the interaction between the inner bearing and at least one interface element or applying magnetic torque to the inner bearing using an electromagnetic field based at least in part on a status of the inner bearing, of a rotor, or both.

23. The method of claim 22, wherein the inner bearing comprises a foil bearing or a leaf-type bearing and wherein controlling the interaction between the inner bearing and at least one interface element or applying magnetic torque to the inner bearing using an electromagnetic field is based at least in part on a status of the inner bearing, wherein the status of the inner bearing comprises a rotational speed of the inner bearing, a rotational speed of the outer bearing, presence of an air or gas film adjacent to a surface of the inner bearing, or any combination thereof.

24. The method of claim 22, wherein the inner bearing comprises a foil bearing or a leaf-type bearing and further comprising causing the inner bearing to rotate with the rotor when the rotor is below a threshold rotational speed, and causing the inner bearing to become substantially still to induce formation of an air or other gas film to form between the inner bearing and a rotor once the rotor reaches a threshold rotational speed.

25. The method of claim 22, wherein the inner bearing comprises a foil bearing or a leaf-type bearing and further comprising causing the inner bearing to rotate in an opposite direction relative to the rotor when the rotor is below a threshold rotational speed, and causing the inner bearing to become substantially still to induce formation of an air or other gas film to form between the inner bearing and a rotor once the relative rotational speed between the rotor and the inner bearing reaches a threshold value.

26. A system comprising:
a rotor;
a stator;
a bearing comprising:
an inner bearing; and
an outer bearing, the outer bearing connected to the stator; and
a bearing engagement system configured to control a rotation of the inner bearing, the bearing engagement system comprising:
a displacer configured to laterally displace at least the inner bearing, displace an interface element, or both; or
an electromagnet configured to generate a magnetic field to apply a magnetic torque to the inner bearing.

27. The system of claim 26, wherein the bearing engagement system comprises the displacer configured to displace the inner bearing, and wherein the rotor comprises a first interface element, the stator comprises a second interface element, and the displacer comprises a linear actuator configured to displace the inner bearing to contact the first interface element or the second interface element, wherein when in contact with the inner bearing the first interface element is configured to cause the inner bearing to rotate with the rotor and the second interface element is configured to maintain the inner bearing still with the stator.

28. The system of claim 26, wherein the bearing engagement system comprises the displacer configured to displace an interface element, wherein the interface element is located on a rotor protrusion extending from the rotor, or from a stator protrusion extending from the stator, the displacer comprises a linear actuator configured to displace the rotor protrusion or the stator protrusion towards and away from the inner bearing to cause the interface element to contact or separate from the inner bearing and thereby to engage or disengage the inner bearing.

29. The system of claim 26, the bearing engagement system comprising the electromagnet, wherein the electromagnet comprises one or more electromagnets and further comprising a controller configured to control operation of the one or more electromagnets.

30. The system of claim 26, the inner bearing further comprising a gas bearing, and the outer bearing further comprising a roller bearing, a ball bearing, a lubricated bearing, or any combination thereof.

31. The system of claim 26, the inner bearing further comprising a roller bearing, a ball bearing, a lubricated bearing, or any combination thereof and the outer bearing further comprising a gas bearing.

32. The system of claim 26, wherein the bearing comprises a radial bearing or an axial bearing.

33. The system of claim 26, wherein the bearing comprises a hybrid bearing where the inner bearing is different from the outer bearing.

34. The system of claim 26, wherein the bearing system is configured such that the outer bearing is engaged when the inner bearing rotates.

35. The system of claim 26, further comprising a vibration dampener.

36. The system of claim 26, further comprising a controller configured to control the displacer, the electromagnet, or both.

37. The system of claim 26, wherein the bearing is lubricant-free.
